(19) United States
(12) Patent Application Publication
(10) Pub. No.: US 2025/0240778 A1
(43) Pub. Date: Jul. 24, 2025

(54) SIGNALING DETAILS FOR COORDINATED TIME DIVISION MULTIPLE ACCESS

(71) Applicant: QUALCOMM Incorporated, San Diego, CA (US)

(72) Inventors: Sanket Sanjay KALAMKAR, San Diego, CA (US); Gaurang NAIK, San Diego, CA (US); Abhishek Pramod PATIL, San Diego, CA (US); George CHERIAN, San Diego, CA (US); Alfred ASTERJADHI, San Diego, CA (US); Sai Yiu Duncan HO, San Diego, CA (US); Giovanni CHISCI, San Diego, CA (US); Sherief HELWA, San Diego, CA (US)

(21) Appl. No.: 19/025,756

(22) Filed: Jan. 16, 2025

Related U.S. Application Data
(60) Provisional application No. 63/623,094, filed on Jan. 19, 2024.

(51) Int. Cl. H04W 72/12

(52) U.S. Cl. CPC H04W 72/12

(57) ABSTRACT

This disclosure provides methods, components, devices and systems for signaling details for coordinated time division multiple access (C-TDMA). Some aspects more specifically relate to signaling details for coordinated time division multiple access. In some examples, an access point (AP) may perform a channel access procedure to obtain access to a wireless medium for communications during a transmission opportunity (TXOP). In some examples, the AP (such as a sharing AP) may share the TXOP with another AP (such as a shared AP) during at least a portion of the TXOP. The sharing AP may transmit one or more messages indicating communication parameters for a second AP to share the portion of the TXOP.

### CROSS REFERENCE

The present application for patent claims the benefit of Provisional Patent Application No. 63/623,094 by KALAMKAR et al., entitled “SIGNALING DETAILS FOR COORDINATED TIME DIVISION MULTIPLE ACCESS,” filed Jan. 19, 2024, assigned to the assignee hereof and hereby expressly incorporated by reference herein.

### TECHNICAL FIELD

This disclosure relates generally to wireless communication and, more specifically, to signaling details for coordinated time division multiple access (C-TDMA).

### DESCRIPTION OF THE RELATED TECHNOLOGY

A wireless local area network (WLAN) may be formed by one or more wireless access points (APs) that provide a shared wireless communication medium for use by multiple client devices also referred to as wireless stations (STAs). The basic building block of a WLAN conforming to the Institute of Electrical and Electronics Engineers (IEEE) 802.11 family of standards is a Basic Service Set (BSS), which is managed by an AP. Each BSS is identified by a Basic Service Set Identifier (BSSID) that is advertised by the AP. An AP periodically broadcasts beacon frames to enable any STAs within wireless range of the AP to establish or maintain a communication link with the WLAN.

### SUMMARY

The systems, methods, and devices of this disclosure each have several innovative aspects, no single one of which is solely responsible for the desirable attributes disclosed herein.

One innovative aspect of the subject matter described in this disclosure can be implemented in a method by a first access point (AP). The method may include performing a channel access procedure to obtain access to a wireless medium for communications during a transmission opportunity (TXOP), the TXOP corresponding to a duration during which the first AP has the access to the wireless medium and transmitting one or more messages indicating communication parameters for a second AP to share a portion of the TXOP with the first AP.

Another innovative aspect of the subject matter described in this disclosure can be implemented in a first AP. The first AP may include a processing system that includes processor circuitry and memory circuitry that stores code. The processing system may be configured to cause the first AP to perform a channel access procedure to obtain access to a wireless medium for communications during a TXOP, the TXOP corresponding to a duration during which the first AP has the access to the wireless medium and transmit one or more messages indicating communication parameters for a second AP to share a portion of the TXOP with the first AP.

Another innovative aspect of the subject matter described in this disclosure can be implemented in a first AP. The first AP may include means for performing a channel access procedure to obtain access to a wireless medium for communications during a TXOP, the TXOP corresponding to a duration during which the first AP has the access to the wireless medium and means for transmitting one or more messages indicating communication parameters for a second AP to share a portion of the TXOP with the first AP.

Another innovative aspect of the subject matter described in this disclosure can be implemented in a non-transitory computer-readable medium storing code. The code may include instructions executable by one or more processors to perform a channel access procedure to obtain access to a wireless medium for communications during a TXOP, the TXOP corresponding to a duration during which the first AP has the access to the wireless medium and transmit one or more messages indicating communication parameters for a second AP to share a portion of the TXOP with the first AP.

In some examples of the method, first APs, and non-transitory computer-readable medium described herein, the one or more messages include a first message that indicates a first set of communication parameters for the second AP to share the portion of the TXOP and a second message that indicates a second set of communication parameters for the second AP to share the portion of the TXOP with the first AP.

In some examples of the method, first APs, and non-transitory computer-readable medium described herein, the first message may be a schedule announcement frame or a polling frame.

In some examples of the method, first APs, and non-transitory computer-readable medium described herein, the second message may be a TXOP allocation frame.

In some examples of the method, first APs, and non-transitory computer-readable medium described herein, the first message, the second message, or both indicate the duration of the TXOP.

In some examples of the method, first APs, and non-transitory computer-readable medium described herein, the first message, the second message, or both, indicate a second duration of the portion of the TXOP that may be shared with the second AP.

In some examples of the method, first APs, and non-transitory computer-readable medium described herein, the first message, the second message, or both indicate a traffic type, a traffic category, a traffic flow, or a combination thereof associated with communication by the second AP during the portion of the TXOP that may be shared with the second AP.

In some examples of the method, first APs, and non-transitory computer-readable medium described herein, the first message indicates an estimated time offset between transmission of the first message and a beginning of the portion of the TXOP that may be shared with the second AP.

In some examples of the method, first APs, and non-transitory computer-readable medium described herein, the first message, the second message, or both indicate an identifier of a wireless communication device served by the second AP during the portion of the TXOP that may be shared with the second AP.

Details of one or more implementations of the subject matter described in this disclosure are set forth in the accompanying drawings and the description below. Other features, aspects, and advantages will become apparent from the description, the drawings and the claims. Note that the relative dimensions of the following figures may not be drawn to scale.

### BRIEF DESCRIPTION OF THE DRAWINGS

FIG. 1 shows a pictorial diagram of an example wireless communication network.

FIG. 2 shows an example protocol data unit (PDU) usable for communications between a wireless access point (AP) and one or more wireless stations (STAs).

FIG. 3 shows an example physical layer (PHY) protocol data unit (PPDU) usable for communications between a wireless AP and one or more wireless STAs.

FIG. 4 shows a hierarchical format of an example PPDU usable for communications between a wireless AP and one or more wireless STAs.

FIG. 5 shows an example of a timing diagram that supports signaling details for coordinated time division multiple access (C-TDMA).

FIG. 6 shows an example of a frame that supports signaling details for C-TDMA.

FIG. 7 shows an example of a frame that supports signaling details for C-TDMA.

FIG. 8 shows an example of a timing diagram that supports signaling details for C-TDMA.

FIG. 9 shows an example of a frame that supports signaling details for C-TDMA.

FIG. 10 shows an example of a frame that supports signaling details for C-TDMA.

FIG. 11 shows a block diagram of an example wireless communication device that supports signaling details for C-TDMA.

FIG. 12 shows a flowchart illustrating an example process performable by or at a first access point (AP) that supports signaling details for C-TDMA.

Like reference numbers and designations in the various drawings indicate like elements.

### DETAILED DESCRIPTION

The following description is directed to some particular examples for the purposes of describing innovative aspects of this disclosure. However, a person having ordinary skill in the art will readily recognize that the teachings herein can be applied in a multitude of different ways. Some or all of the described examples may be implemented in any device, system or network that is capable of transmitting and receiving radio frequency (RF) signals according to one or more of the Institute of Electrical and Electronics Engineers (IEEE) 802.11 standards, the IEEE 802.15 standards, the Bluetooth® standards as defined by the Bluetooth Special Interest Group (SIG), or the Long Term Evolution (LTE), 3G, 4G, 5G (New Radio (NR)) or 6G standards promulgated by the 3rd Generation Partnership Project (3GPP), among others. The described examples can be implemented in any suitable device, component, system or network that is capable of transmitting and receiving RF signals according to one or more of the following technologies or techniques: code division multiple access (CDMA), time division multiple access (TDMA), orthogonal frequency division multiplexing (OFDM), frequency division multiple access (FDMA), orthogonal FDMA (OFDMA), single-carrier FDMA (SC-FDMA), spatial division multiple access (SDMA), rate-splitting multiple access (RSMA), multi-user shared access (MUSA), single-user (SU) multiple-input multiple-output (MIMO) and multi-user (MU)-MIMO (MU-MIMO). The described examples also can be implemented using other wireless communication protocols or RF signals suitable for use in one or more of a wireless personal area network (WPAN), a wireless local area network (WLAN), a wireless wide area network (WWAN), a wireless metropolitan area network (WMAN), a non-terrestrial network (NTN), or an internet of things (IOT) network.

Various aspects relate generally to wireless communication. Some aspects more specifically relate to signaling details for coordinated time division multiple access (C-TDMA). In some examples, an access point (AP) may perform a channel access procedure (such as a listen before talk (LBT) procedure) to obtain access to a wireless medium for communications during a transmission opportunity (TXOP). The TXOP may refer to a duration of time during which the first AP has access to the wireless medium. In some examples, the AP (such as a sharing AP, a primary AP) may share the TXOP with another AP (such as a shared AP, a secondary AP) during at least a portion of the TXOP. Sharing of the TXOP may refer to multiple APs transmitting messages during respective portions of the TXOP. For example, the sharing AP may share the TXOP with the shared AP which may enable the shared AP, which is different from the TXOP holder (e.g., and has not been explicitly granted access to the wireless medium), to transmit one or more messages during at least a portion of the TXOP. The portion of the TXOP that is shared may be referred to herein as the shared TXOP. Both the sharing AP and the shared AP may communicate with one another (e.g., via one or more configuration messages, frames) to facilitate the sharing of the TXOP with the shared AP (such as sharing the TXOP during the shared TXOP). For example, the sharing AP may transmit one or more messages indicating one or more communication parameters for a second AP to share the portion of the TXOP. The sharing AP may signal such communication parameters to the shared AP via one or more frames, which may include a schedule announcement frame and a TXOP allocation frame. The information to be signaled may include an expected duration of the overall TXOP for which the sharing AP has access to the medium, a time offset indicating when the TXOP will be shared with a specified AP, a duration of the portion of the TXOP that is being shared with a specified AP, a traffic category, traffic flow, or traffic characteristic for which the shared AP may use the TXOP, or one or more STAs that are served during the shared TXOP, or a combination thereof.

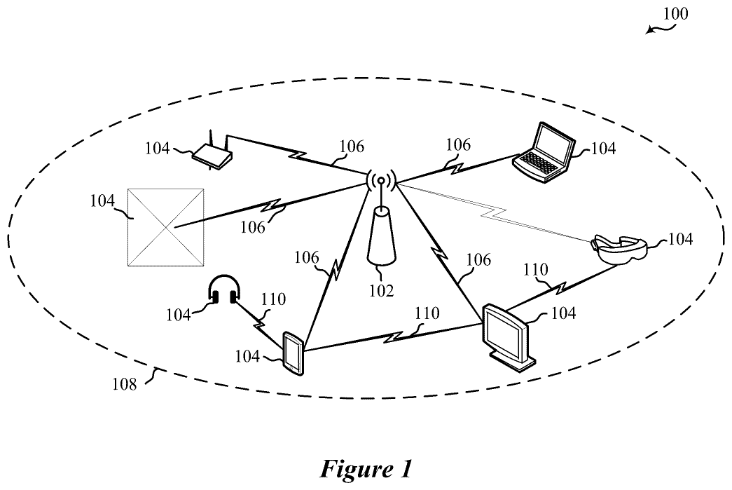

FIG. 1 shows a pictorial diagram of an example wireless communication network 100. According to some aspects, the wireless communication network 100 may be an example of a wireless local area network (WLAN) such as a Wi-Fi network. For example, the wireless communication network 100 may be a network implementing at least one of the IEEE 802.11 family of wireless communication protocol standards (such as defined by the IEEE 802.11-2020 specification or amendments thereof including, but not limited to, 802.11ay, 802.11ax, 802.11az, 802.11ba, 802.11bc, 802.11bd, 802.11be, 802.11bf, and 802.11bn). In some other examples, the wireless communication network 100 may be an example of a cellular radio access network (RAN), such as a 5G or 6G RAN that implements one or more cellular protocols such as those specified in one or more 3GPP standards. In some other examples, the wireless communication network 100 may include a WLAN that functions in an interoperable or converged manner with one or more cellular RANs to provide greater or enhanced network coverage to wireless communication devices within the wireless communication network 100 or to enable such devices to connect to a cellular network's core, such as to access the network management capabilities and functionality offered by the cellular network core. In some other examples, the wireless communication network 100 may include a WLAN that functions in an interoperable or converged manner with one or more personal area networks, such as a network implementing Bluetooth or other wireless technologies, to provide greater or enhanced network coverage or to provide or enable other capabilities, functionality, applications or services.

The wireless communication network 100 may include numerous wireless communication devices including at least one wireless access point (AP) 102 and any number of wireless stations (STAs) 104. While only one AP 102 is shown in FIG. 1, the wireless communication network 100 may include multiple APs 102. The AP 102 may be or represent various different types of network entities including, but not limited to, a home networking AP, an enterprise-level AP, a single-frequency AP, a dual-band simultaneous (DBS) AP, a tri-band simultaneous (TBS) AP, a standalone AP, a non-standalone AP, a software-enabled AP (soft AP), and a multi-link AP (also referred to as an AP multi-link device (MLD)), as well as cellular (such as 3GPP, 4G LTE, 5G or 6G) base stations or other cellular network nodes such as a Node B, an evolved Node B (eNB), a gNB, a transmission reception point (TRP) or another type of device or equipment included in a radio access network (RAN), including Open-RAN (O-RAN) network entities, such as a central unit (CU), a distributed unit (DU) or a radio unit (RU).

Each of the STAs 104 also may be referred to as a mobile station (MS), a mobile device, a mobile handset, a wireless handset, an access terminal (AT), a user equipment (UE), a subscriber station (SS), or a subscriber unit, among other examples. The STAs 104 may represent various devices such as mobile phones, other handheld or wearable communication devices, netbooks, notebook computers, tablet computers, laptops, Chromebooks, augmented reality (AR), virtual reality (VR), mixed reality (MR) or extended reality (XR) wireless headsets or other peripheral devices, wireless earbuds, other wearable devices, display devices (such as TVs, computer monitors or video gaming consoles), video game controllers, navigation systems, music or other audio or stereo devices, remote control devices, printers, kitchen appliances (including smart refrigerators) or other household appliances, key fobs (such as for passive keyless entry and start (PKES) systems), Internet of Things (IoT) devices, and vehicles, among other examples.

A single AP 102 and an associated set of STAs 104 may be referred to as a basic service set (BSS), which is managed by the respective AP 102. FIG. 1 additionally shows an example coverage area 108 of the AP 102, which may represent a basic service area (BSA) of the wireless communication network 100. The BSS may be identified by STAs 104 and other devices by a service set identifier (SSID), as well as a basic service set identifier (BSSID), which may be a medium access control (MAC) address of the AP 102. The AP 102 may periodically broadcast beacon frames (“beacons”) including the BSSID to enable any STAs 104 within wireless range of the AP 102 to “associate” or re-associate with the AP 102 to establish a respective communication link 106 (hereinafter also referred to as a “Wi-Fi link”), or to maintain a communication link 106, with the AP 102. For example, the beacons may include an identification or indication of a primary channel used by the respective AP 102 as well as a timing synchronization function (TSF) for establishing or maintaining timing synchronization with the AP 102. The AP 102 may provide access to external networks to various STAs 104 in the wireless communication network 100 via respective communication links 106.

To establish a communication link 106 with an AP 102, each of the STAs 104 is configured to perform passive or active scanning operations (“scans”) on frequency channels in one or more frequency bands (such as the 2.4 GHz, 5 GHz, 6 GHz, 45 GHz, or 60 GHz bands). To perform passive scanning, a STA 104 listens for beacons, which are transmitted by respective APs 102 at periodic time intervals referred to as target beacon transmission times (TBTTs). To perform active scanning, a STA 104 generates and sequentially transmits probe requests on each channel to be scanned and listens for probe responses from APs 102. Each STA 104 may identify, determine, ascertain, or select an AP 102 with which to associate in accordance with the scanning information obtained through the passive or active scans, and to perform authentication and association operations to establish a communication link 106 with the selected AP 102. The selected AP 102 assigns an association identifier (AID) to the STA 104 at the culmination of the association operations, which the AP 102 uses to track the STA 104.

As a result of the increasing ubiquity of wireless networks, a STA 104 may have the opportunity to select one of multiple BSSs within range of the STA 104 or to select among multiple APs 102 that together form an extended service set (ESS) including multiple connected BSSs. For example, the wireless communication network 100 may be connected to a wired or wireless distribution system that may enable multiple APs 102 to be connected in such an ESS. As such, a STA 104 may be covered by more than one AP 102 and may associate with different APs 102 at different times for different transmissions. Additionally, after association with an AP 102, a STA 104 also may periodically scan its surroundings to find a more suitable AP 102 with which to associate. For example, a STA 104 that is moving relative to its associated AP 102 may perform a “roaming” scan to find another AP 102 having more desirable network characteristics such as a greater received signal strength indicator (RSSI) or a reduced traffic load.

In some examples, STAs 104 may form networks without APs 102 or other equipment other than the STAs 104 themselves. One example of such a network is an ad hoc network (or wireless ad hoc network). Ad hoc networks may alternatively be referred to as mesh networks or peer-to-peer (P2P) networks. In some examples, ad hoc networks may be implemented within a larger network such as the wireless communication network 100. In such examples, while the STAs 104 may be capable of communicating with each other through the AP 102 using communication links 106, STAs 104 also may communicate directly with each other via direct wireless communication links 110. Additionally, two STAs 104 may communicate via a direct wireless communication link 110 regardless of whether both STAs 104 are associated with and served by the same AP 102. In such an ad hoc system, one or more of the STAs 104 may assume the role filled by the AP 102 in a BSS. Such a STA 104 may be referred to as a group owner (GO) and may coordinate transmissions within the ad hoc network. Examples of direct wireless communication links 110 include Wi-Fi Direct connections, connections established by using a Wi-Fi Tunneled Direct Link Setup (TDLS) link, and other P2P group connections.

In some networks, the AP 102 or the STAs 104, or both, may support applications associated with high throughput or low-latency requirements, or may provide lossless audio to one or more other devices. For example, the AP 102 or the STAs 104 may support applications and use cases associated with ultra-low-latency (ULL), such as ULL gaming, or streaming lossless audio and video to one or more personal audio devices (such as peripheral devices) or AR/VR/MR/XR headset devices. In scenarios in which a user uses two or more peripheral devices, the AP 102 or the STAs 104 may support an extended personal audio network enabling communication with the two or more peripheral devices. Additionally, the AP 102 and STAs 104 may support additional ULL applications such as cloud-based applications (such as VR cloud gaming) that have ULL and high throughput requirements.

As indicated above, in some implementations, the AP 102 and the STAs 104 may function and communicate (via the respective communication links 106) according to one or more of the IEEE 802.11 family of wireless communication protocol standards. These standards define the WLAN radio and baseband protocols for the physical (PHY) and MAC layers. The AP 102 and STAs 104 transmit and receive wireless communications (hereinafter also referred to as “Wi-Fi communications” or “wireless packets”) to and from one another in the form of PHY protocol data units (PPDUs).

Each PPDU is a composite structure that includes a PHY preamble and a payload that is in the form of a PHY service data unit (PSDU). The information provided in the preamble may be used by a receiving device to decode the subsequent data in the PSDU. In instances in which a PPDU is transmitted over a bonded or wideband channel, the preamble fields may be duplicated and transmitted in each of multiple component channels. The PHY preamble may include both a legacy portion (or “legacy preamble”) and a non-legacy portion (or “non-legacy preamble”). The legacy preamble may be used for packet detection, automatic gain control and channel estimation, among other uses. The legacy preamble also may generally be used to maintain compatibility with legacy devices. The format of, coding of, and information provided in the non-legacy portion of the preamble is associated with the particular IEEE 802.11 wireless communication protocol to be used to transmit the payload.

The APs 102 and STAs 104 in the wireless communication network 100 may transmit PPDUs over an unlicensed spectrum, which may be a portion of spectrum that includes frequency bands traditionally used by Wi-Fi technology, such as the 2.4 GHz, 5 GHz, 6 GHz, 45 GHz, and 60 GHz bands. Some examples of the APs 102 and STAs 104 described herein also may communicate in other frequency bands that may support licensed or unlicensed communications. For example, the APs 102 or STAs 104, or both, also may be capable of communicating over licensed operating bands, where multiple operators may have respective licenses to operate in the same or overlapping frequency ranges. Such licensed operating bands may map to or be associated with frequency range designations of FRI (410 MHz-7.125 GHz), FR2 (24.25 GHz-52.6 GHz), FR3 (7.125 GHz-24.25 GHz), FR4a or FR4-1 (52.6 GHz-71 GHz), FR4 (52.6 GHz-114.25 GHz), and FR5 (114.25 GHz-300 GHz).

Each of the frequency bands may include multiple sub-bands and frequency channels (also referred to as subchannels). The terms “channel” and “subchannel” may be used interchangeably herein, as each may refer to a portion of frequency spectrum within a frequency band (such as a 20 MHz, 40 MHz, 80 MHz, or 160 MHz portion of frequency spectrum) via which communication between two or more wireless communication devices may occur. For example, PPDUs conforming to the IEEE 802.11n, 802.11ac, 802.11ax, 802.11be and 802.11bn standard amendments may be transmitted over one or more of the 2.4 GHz, 5 GHz, or 6 GHz bands, each of which is divided into multiple 20 MHz channels. As such, these PPDUs are transmitted over a physical channel having a minimum bandwidth of 20 MHz, but larger channels may be formed through channel bonding. For example, PPDUs may be transmitted over physical channels having bandwidths of 40 MHz, 80 MHz, 160 MHz, 240 MHz, 320 MHz, 480 MHz, or 640 MHz by bonding together multiple 20 MHz channels.

An AP 102 may determine or select an operating or operational bandwidth for the STAs 104 in its BSS and select a range of channels within a band to provide that operating bandwidth. For example, the AP 102 may select sixteen 20 MHz channels that collectively span an operating bandwidth of 320 MHz. Within the operating bandwidth, the AP 102 may typically select a single primary 20 MHz channel on which the AP 102 and the STAs 104 in its BSS monitor for contention-based access schemes. In some examples, the AP 102 or the STAs 104 may be capable of monitoring only a single primary 20 MHz channel for packet detection (such as for detecting preambles of PPDUs). Conventionally, any transmission by an AP 102 or a STA 104 within a BSS must involve transmission on the primary 20 MHz channel. As such, in conventional systems, the transmitting device must contend on and win a TXOP on the primary channel to transmit anything at all. However, some APs 102 and STAs 104 supporting ultra-high reliability (UHR) communications or communication according to the IEEE 802.11bn standard amendment may be configured to operate, monitor, contend and communicate using multiple primary 20 MHz channels. Such monitoring of multiple primary 20 MHz channels may be sequential such that responsive to determining, ascertaining or detecting that a first primary 20 MHz channel is not available, a wireless communication device may switch to monitoring and contending using a second primary 20 MHz channel. Additionally, or alternatively, a wireless communication device may be configured to monitor multiple primary 20 MHz channels in parallel. In some examples, a first primary 20 MHz channel may be referred to as a main primary (M-Primary) channel and one or more additional, second primary channels may each be referred to as an opportunistic primary (O-Primary) channel. For example, if a wireless communication device measures, identifies, ascertains, detects, or otherwise determines that the M-Primary channel is busy or occupied (such as due to an overlapping BSS (OBSS) transmission), the wireless communication device may switch to monitoring and contending on an O-Primary channel. In some examples, the M-Primary channel may be used for beaconing and serving legacy client devices and an O-Primary channel may be specifically used by non-legacy (such as UHR- or IEEE 802.11bn-compatible) devices for opportunistic access to spectrum that may be otherwise under-utilized.

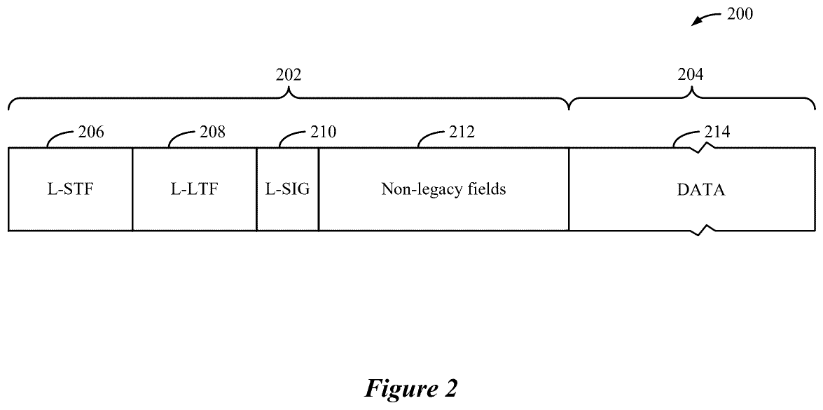

FIG. 2 shows an example protocol data unit (PDU) 200 usable for wireless communication between a wireless AP and one or more wireless STAs. For example, the AP and STAs may be examples of the AP 102 and the STAs 104 described with reference to FIG. 1. The PDU 200 may be configured as a PPDU. As shown, the PDU 200 includes a PHY preamble 202 and a PHY payload 204. For example, the preamble 202 may include a legacy portion that itself includes a legacy short training field (L-STF) 206, which may consist of two symbols, a legacy long training field (L-LTF) 208, which may consist of two symbols, and a legacy signal field (L-SIG) 210, which may consist of two symbols. The legacy portion of the preamble 202 may be configured according to the IEEE 802.11a wireless communication protocol standard. The preamble 202 also may include a non-legacy portion including one or more non-legacy fields 212, for example, conforming to one or more of the IEEE 802.11 family of wireless communication protocol standards.

The L-STF 206 generally enables a receiving device (such as an AP 102 or a STA 104) to perform coarse timing and frequency tracking and automatic gain control (AGC). The L-LTF 208 generally enables the receiving device to perform fine timing and frequency tracking and also to perform an initial estimate of the wireless channel. The L-SIG 210 generally enables the receiving device to determine (such as obtain, select, identify, detect, ascertain, calculate, or compute) a duration of the PDU and to use the determined duration to avoid transmitting on top of the PDU. The legacy portion of the preamble, including the L-STF 206, the L-LTF 208 and the L-SIG 210, may be modulated according to a binary phase shift keying (BPSK) modulation scheme. The payload 204 may be modulated according to a BPSK modulation scheme, a quadrature BPSK (Q-BPSK) modulation scheme, a quadrature amplitude modulation (QAM) modulation scheme, or another appropriate modulation scheme. The payload 204 may include a PSDU including a data field (DATA) 214 that, in turn, may carry higher layer data, for example, in the form of MAC protocol data units (MPDUs) or an aggregated MPDU (A-MPDU).

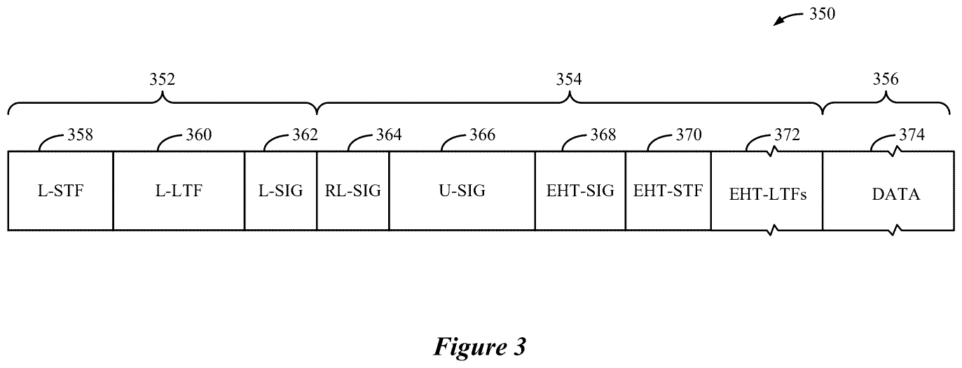

FIG. 3 shows an example physical layer (PHY) protocol data unit (PPDU) 350 usable for communications between a wireless AP and one or more wireless STAs. For example, the AP and STAs may be examples of the AP 102 and the STAs 104 described with reference to FIG. 1. As shown, the PPDU 350 includes a PHY preamble, that includes a legacy portion 352 and a non-legacy portion 354, and a payload 356 that includes a data field 374. The legacy portion 352 of the preamble includes an L-STF 358, an L-LTF 360, and an L-SIG 362. The non-legacy portion 354 of the preamble includes a repetition of L-SIG (RL-SIG) 364 and multiple wireless communication protocol version-dependent signal fields after RL-SIG 364. For example, the non-legacy portion 354 may include a universal signal field 366 (referred to herein as “U-SIG 366”) and an EHT signal field 368 (referred to herein as “EHT-SIG 368”). The presence of RL-SIG 364 and U-SIG 366 may indicate to EHT- or later version-compliant STAs 104 that the PPDU 350 is an EHT PPDU or a PPDU conforming to any later (post-EHT) version of a new wireless communication protocol conforming to a future IEEE 802.11 wireless communication protocol standard. One or both of U-SIG 366 and EHT-SIG 368 may be structured as, and carry version-dependent information for, other wireless communication protocol versions associated with amendments to the IEEE family of standards beyond EHT. For example, U-SIG 366 may be used by a receiving device (such as an AP 102 or a STA 104) to interpret bits in one or more of EHT-SIG 368 or the data field 374. Like L-STF 358, L-LTF 360, and L-SIG 362, the information in U-SIG 366 and EHT-SIG 368 may be duplicated and transmitted in each of the component 20 MHz channels in instances involving the use of a bonded channel.

The non-legacy portion 354 further includes an additional short training field 370 (referred to herein as “EHT-STF 370,” although it may be structured as, and carry version-dependent information for, other wireless communication protocol versions beyond EHT) and one or more additional long training fields 372 (referred to herein as “EHT-LTFs 372,” although they may be structured as, and carry version-dependent information for, other wireless communication protocol versions beyond EHT). EHT-STF 370 may be used for timing and frequency tracking and AGC, and EHT-LTF 372 may be used for more refined channel estimation.

EHT-SIG 368 may be used by an AP 102 to identify and inform one or multiple STAs 104 that the AP 102 has scheduled uplink (UL) or downlink (DL) resources for them. EHT-SIG 368 may be decoded by each compatible STA 104 served by the AP 102. EHT-SIG 368 may generally be used by the receiving device to interpret bits in the data field 374. For example, EHT-SIG 368 may include resource unit (RU) allocation information, spatial stream configuration information, and per-user (such as STA-specific) signaling information. Each EHT-SIG 368 may include a common field and at least one user-specific field. In the context of OFDMA, the common field may indicate RU distributions to multiple STAs 104, indicate the RU assignments in the frequency domain, indicate which RUs are allocated for MU-MIMO transmissions and which RUs correspond to OFDMA transmissions, and the number of users in allocations, among other examples. The user-specific fields are assigned to particular STAs 104 and carry STA-specific scheduling information such as user-specific MCS values and user-specific RU allocation information. Such information enables the respective STAs 104 to identify and decode corresponding RUs in the associated data field 374.

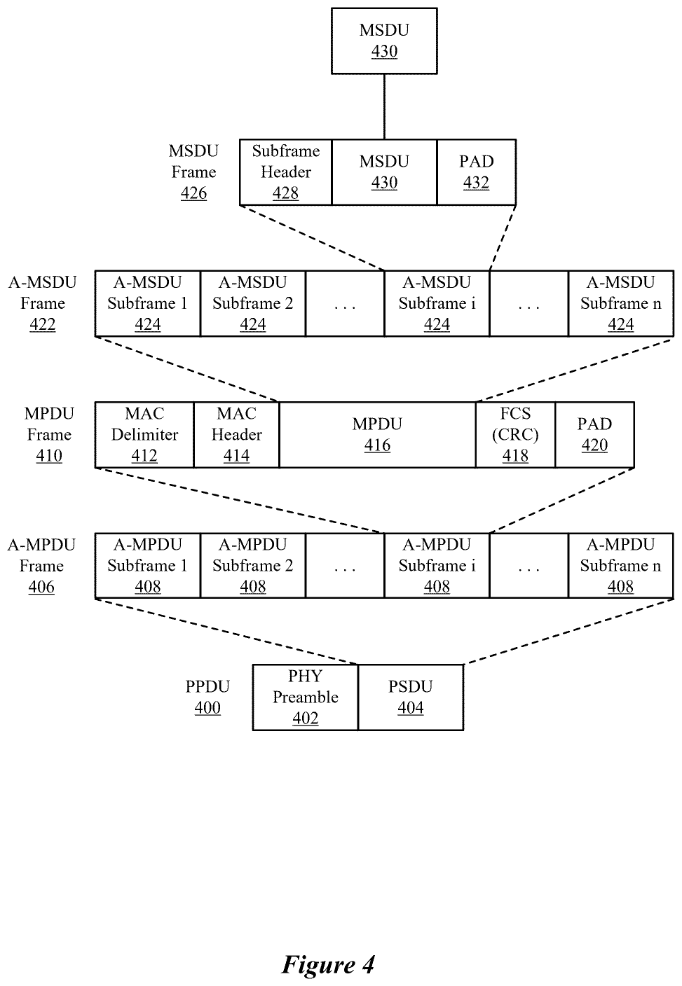

FIG. 4 shows a hierarchical format of an example PPDU usable for communications between a wireless AP and one or more wireless STAs. For example, the AP and STAs may be examples of the AP 102 and the STAs 104 described with reference to FIG. 1. As described, each PPDU 400 includes a PHY preamble 402 and a PSDU 404. Each PSDU 404 may represent (or “carry”) one or more MAC protocol data units (MPDUs) 416. For example, each PSDU 404 may carry an aggregated MPDU (A-MPDU) 406 that includes an aggregation of multiple A-MPDU subframes 408. Each A-MPDU subframe 408 may include an MPDU frame 410 that includes a MAC delimiter 412 and a MAC header 414 prior to the accompanying MPDU 416, which includes the data portion (“payload” or “frame body”) of the MPDU frame 410. Each MPDU frame 410 also may include a frame check sequence (FCS) field 418 for error detection (such as the FCS field 418 may include a cyclic redundancy check (CRC)) and padding bits 420. The MPDU 416 may carry one or more MAC service data units (MSDUs) 430. For example, the MPDU 416 may carry an aggregated MSDU (A-MSDU) 422 including multiple A-MSDU subframes 424. Each A-MSDU subframe 424 may be associated with an MSDU frame 426 and may contain a corresponding MSDU 430 preceded by a subframe header 428 and, in some examples, followed by padding bits 432.

Referring back to the MPDU frame 410, the MAC delimiter 412 may serve as a marker of the start of the associated MPDU 416 and indicate the length of the associated MPDU 416. The MAC header 414 may include multiple fields containing information that defines or indicates characteristics or attributes of data encapsulated within the frame body. The MAC header 414 includes a duration field indicating a duration extending from the end of the PPDU until at least the end of an acknowledgement (ACK) or Block ACK (BA) of the PPDU that is to be transmitted by the receiving wireless communication device. The use of the duration field serves to reserve the wireless medium for the indicated duration and enables the receiving device to establish its network allocation vector (NAV). The MAC header 414 also includes one or more fields indicating addresses for the data encapsulated within the frame body. For example, the MAC header 414 may include a combination of a source address, a transmitter address, a receiver address or a destination address. The MAC header 414 may further include a frame control field containing control information. The frame control field may specify a frame type, for example, a data frame, a control frame, or a management frame.

In some wireless communication systems, wireless communication between an AP 102 and an associated STA 104 may be secured. For example, either an AP 102 or a STA 104 may establish a security key for securing wireless communication between itself and the other device and may encrypt the contents of the data and management frames using the security key. In some examples, the control frame and fields within the MAC header of the data or management frames, or both, also may be secured either via encryption or via an integrity check (such as by generating a message integrity check (MIC) for one or more relevant fields.

Access to the shared wireless medium is generally governed by a distributed coordination function (DCF). With a DCF, there is generally no centralized master device allocating time and frequency resources of the shared wireless medium. On the contrary, before a wireless communication device, such as an AP 102 or a STA 104, is permitted to transmit data, it may wait for a particular time and contend for access to the wireless medium. The DCF is implemented through the use of time intervals (including the slot time (or “slot interval”) and the inter-frame space (IFS). IFS provides priority access for control frames used for proper network operation. Transmissions may begin at slot boundaries. Different varieties of IFS exist including the short IFS (SIFS), the distributed IFS (DIFS), the extended IFS (EIFS), and the arbitration IFS (AIFS). The values for the slot time and IFS may be provided by a suitable standard specification, such as one or more of the IEEE 802.11 family of wireless communication protocol standards.

In some examples, the wireless communication device (such as the AP 102 or the STA 104) may implement the DCF through the use of carrier sense multiple access (CSMA) with collision avoidance (CA) (CSMA/CA) techniques. According to such techniques, before transmitting data, the wireless communication device may perform a clear channel assessment (CCA) and may determine (such as identify, detect, ascertain, calculate, or compute) that the relevant wireless channel is idle. The CCA includes both physical (PHY-level) carrier sensing and virtual (MAC-level) carrier sensing. Physical carrier sensing is accomplished via a measurement of the received signal strength of a valid frame, which is compared to a threshold to determine (such as identify, detect, ascertain, calculate, or compute) whether the channel is busy. For example, if the received signal strength of a detected preamble is above a threshold, the medium is considered busy. Physical carrier sensing also includes energy detection. Energy detection involves measuring the total energy the wireless communication device receives regardless of whether the received signal represents a valid frame. If the total energy detected is above a threshold, the medium is considered busy.

Virtual carrier sensing is accomplished via the use of a network allocation vector (NAV), which effectively serves as a time duration that elapses before the wireless communication device may contend for access even in the absence of a detected symbol or even if the detected energy is below the relevant threshold. The NAV is reset each time a valid frame is received that is not addressed to the wireless communication device. When the NAV reaches 0, the wireless communication device performs the physical carrier sensing. If the channel remains idle for the appropriate IFS, the wireless communication device initiates a backoff timer, which represents a duration of time that the device senses the medium to be idle before it is permitted to transmit. If the channel remains idle until the backoff timer expires, the wireless communication device becomes the holder (or “owner”) of a transmit opportunity (TXOP) and may begin transmitting. The TXOP is the duration of time the wireless communication device may transmit frames over the channel after it has “won” contention for the wireless medium. The TXOP duration may be indicated in the U-SIG field of a PPDU. If, on the other hand, one or more of the carrier sense mechanisms indicate that the channel is busy, a MAC controller within the wireless communication device will not permit transmission.

Each time the wireless communication device generates a new PPDU for transmission in a new TXOP, it randomly selects a new backoff timer duration. The available distribution of the numbers that may be randomly selected for the backoff timer is referred to as the contention window (CW). There are different CW and TXOP durations for each of the four access categories (ACs): voice (AC_VO), video (AC_VI), background (AC_BK), and best effort (AC_BE). This enables particular types of traffic to be prioritized in the network.

In some other examples, the wireless communication device (such as the AP 102 or the STA 104) may contend for access to the wireless medium of a WLAN in accordance with an enhanced distributed channel access (EDCA) procedure. A random channel access mechanism such as EDCA may afford high-priority traffic a greater likelihood of gaining medium access than low-priority traffic. The wireless communication device using EDCA may classify data into different access categories. Each AC may be associated with a different priority level and may be assigned a different range of random backoffs (RBOs) so that higher priority data is more likely to win a TXOP than lower priority data (such as by assigning lower RBOs to higher priority data and assigning higher RBOs to lower priority data). Although EDCA increases the likelihood that low-latency data traffic will gain access to a shared wireless medium during a given contention period, unpredictable outcomes of medium access contention operations may prevent low-latency applications from achieving certain levels of throughput or satisfying certain latency requirements.

Some APs and STAs (such as the AP 102 and the STAs 104 described with reference to FIG. 1) may implement spatial reuse techniques. For example, APs 102 and STAs 104 configured for communications using the protocols defined in the IEEE 802.11ax or 802.11be standard amendments may be configured with a BSS color. APs 102 associated with different BSSs may be associated with different BSS colors. A BSS color is a numerical identifier of an AP 102's respective BSS (such as a 6 bit field carried by the SIG field). Each STA 104 may learn its own BSS color upon association with the respective AP 102. BSS color information is communicated at both the PHY and MAC sublayers. If an AP 102 or a STA 104 detects, obtains, selects, or identifies, a wireless packet from another wireless communication device while contending for access, the AP 102 or the STA 104 may apply different contention parameters in accordance with whether the wireless packet is transmitted by, or transmitted to, another wireless communication device (such another AP 102 or STA 104) within its BSS or from a wireless communication device from an overlapping BSS (OBSS), as determined, identified, ascertained, or calculated by a BSS color indication in a preamble of the wireless packet. For example, if the BSS color associated with the wireless packet is the same as the BSS color of the AP 102 or STA 104, the AP 102 or STA 104 may use a first RSSI detection threshold when performing a CCA on the wireless channel. However, if the BSS color associated with the wireless packet is different than the BSS color of the AP 102 or STA 104, the AP 102 or STA 104 may use a second RSSI detection threshold in lieu of using the first RSSI detection threshold when performing the CCA on the wireless channel, the second RSSI detection threshold being greater than the first RSSI detection threshold. In this way, the criteria for winning contention are relaxed when interfering transmissions are associated with an OBSS.

Some APs and STAs (such as the AP 102 and the STAs 104 described with reference to FIG. 1) may implement techniques for spatial reuse that involve participation in a coordinated communication scheme. According to such techniques, an AP 102 may contend for access to a wireless medium to obtain control of the medium for a TXOP. The AP that wins the contention (hereinafter also referred to as a “sharing AP”) may select one or more other APs (hereinafter also referred to as “shared APs”) to share resources of the TXOP. The sharing and shared APs may be located in proximity to one another such that at least some of their wireless coverage areas at least partially overlap. Some examples may specifically involve coordinated AP TDMA or OFDMA techniques for sharing the time or frequency resources of a TXOP. To share its time or frequency resources, the sharing AP may partition the TXOP into multiple time segments or frequency segments each including respective time or frequency resources representing a portion of the TXOP. The sharing AP may allocate the time or frequency segments to itself or to one or more of the shared APs. For example, each shared AP may utilize a partial TXOP assigned by the sharing AP for its uplink or downlink communications with its associated STAs.

In some examples of such TDMA techniques, each portion of a plurality of portions of the TXOP includes a set of time resources that do not overlap with any time resources of any other portion of the plurality of portions of the TXOP. In such examples, the scheduling information may include an indication of time resources, of multiple time resources of the TXOP, associated with each portion of the TXOP. For example, the scheduling information may include an indication of a time segment of the TXOP such as an indication of one or more slots or sets of symbol periods associated with each portion of the TXOP such as for multi-user TDMA.

In some examples of OFDMA techniques, each portion of the plurality of portions of the TXOP includes a set of frequency resources that do not overlap with any frequency resources of any other portion of the plurality of portions. In such examples, the scheduling information may include an indication of frequency resources, of multiple frequency resources of the TXOP, associated with each portion of the TXOP. For example, the scheduling information may include an indication of a bandwidth portion of the wireless channel such as an indication of one or more subchannels or resource units associated with each portion of the TXOP such as for multi-user OFDMA.

In this manner, the sharing AP's acquisition of the TXOP enables communication between one or more additional shared APs and their respective BSSs, subject to appropriate power control and link adaptation. For example, the sharing AP may limit the transmit powers of the selected shared APs such that interference from the selected APs does not prevent STAs associated with the TXOP owner from successfully decoding packets transmitted by the sharing AP. Such techniques may be used to reduce latency because the other APs may determine not to wait to win contention for a TXOP prior to transmitting and receiving data according to conventional CSMA/CA or enhanced distributed channel access (EDCA) techniques. Additionally, by enabling a group of APs 102 associated with different BSSs to participate in a coordinated AP transmission session, during which the group of APs may share at least a portion of a single TXOP obtained by any one of the participating APs, such techniques may increase throughput across the BSSs associated with the participating APs and also may achieve improvements in throughput fairness. Furthermore, with appropriate selection of the shared APs and the scheduling of their respective time or frequency resources, medium utilization may be maximized or otherwise increased while packet loss resulting from OBSS interference is minimized or otherwise reduced. Various implementations may achieve these and other advantages without requiring that the sharing AP or the shared APs be aware of the STAs 104 associated with other BSSs, without requiring a preassigned or dedicated master AP or preassigned groups of APs, and without requiring backhaul coordination between the APs participating in the TXOP.

In some examples in which the signal strengths or levels of interference associated with the selected APs are relatively low (such as less than a given value), or when the decoding error rates of the selected APs are relatively low (such as less than a threshold), the start times of the communications among the different BSSs may be synchronous. Conversely, when the signal strengths or levels of interference associated with the selected APs are relatively high (such as greater than the given value), or when the decoding error rates of the selected APs are relatively high (such as greater than the threshold), the start times may be offset from one another by a time period associated with decoding the preamble of a wireless packet and determining, from the decoded preamble, whether the wireless packet is an intra-BSS packet or is an OBSS packet. For example, the time period between the transmission of an intra-BSS packet and the transmission of an OBSS packet may allow a respective AP (or its associated STAs) to decode the preamble of the wireless packet and obtain the BSS color value carried in the wireless packet to determine whether the wireless packet is an intra-BSS packet or an OBSS packet. In this manner, each of the participating APs and their associated STAs may be able to receive and decode intra-BSS packets in the presence of OBSS interference.

In some examples, the sharing AP may perform polling of a set of un-managed or non-co-managed APs that support coordinated reuse to identify candidates for future spatial reuse opportunities. For example, the sharing AP may transmit one or more spatial reuse poll frames as part of determining one or more spatial reuse criteria and selecting one or more other APs to be shared APs. According to the polling, the sharing AP may receive responses from one or more of the polled APs. In some specific examples, the sharing AP may transmit a coordinated AP TXOP indication (CTI) frame to other APs that indicates time and frequency of resources of the TXOP that may be shared. The sharing AP may select one or more candidate APs upon receiving a coordinated AP TXOP request (CTR) frame from a respective candidate AP that indicates a desire by the respective AP to participate in the TXOP. The poll responses or CTR frames may include a power indication, for example, a receive (RX) power or RSSI measured by the respective AP. In some other examples, the sharing AP may directly measure potential interference of a service supported (such as UL transmission) at one or more APs, and select the shared APs based on the measured potential interference. The sharing AP generally selects the APs to participate in coordinated spatial reuse such that it still protects its own transmissions (which may be referred to as primary transmissions) to and from the STAs in its BSS. The selected APs may be allocated resources during the TXOP as described above.

C-TDMA may enable an AP that owns a TXOP (e.g., the TXOP holder, the sharing AP, the primary AP) to share a portion of the TXOP time with one or more other APs. The scheme is meant to improve latency and reduce contention/collisions. In some examples, a Triggered TXOP Sharing (TXS) communication framework between one or more APs may facilitate C-TDMA (such as APs may use multi-user ready to send (MU-RTS) and MU-RTS TXS frames to identify one or more APs as shared AP(s) and to share TXOP with them).

To facilitate C-TDMA, a first frame, such as the Schedule Announcement frame, and a second frame, such as the TXOP Allocation frame, may be used to signal information such as an expected duration of the overall TXOP acquired by the sharing AP, when the TXOP will be shared with a certain AP, a duration of the TXOP that is being shared, traffic category or traffic flow or traffic characteristic for which the shared AP may use the TXOP, one or more STAs that may be served during the shared TXOP, or a combination thereof.

In some systems, the communication between an AP and its associated non-AP STA may be protected. In some systems, the communication between an AP (such as a sharing AP) and another AP (such as a shared AP) may be protected. For example, a security key may be established or configured between the two devices and contents of the Data and Management frames transmitted between the two devices may be encrypted (e.g., using the security key). In some systems, the Control frame (such as the Schedule Announcement frame, TXOP Allocation frame, or both) and fields within the MAC header of the Data or Management frames may also be protected. Protection of a Control frame or of the MAC header fields may be performed either via encryption or via integrity check (e.g., by generating a message integrity check (MIC) for one or more relevant fields).

In some examples, the sharing AP and one or more shared AP(s) may be affiliated with a single mobility domain (SMD) multi-link device (MLD) such that all the associated clients may seamlessly roam within the coverage of the sharing AP and the shared AP(s).

In some WLANs that support multi-link operations (MLO), a non-AP STA may affiliate with a non-AP multi-link device (MLD) that operates on multiple communication links. Likewise, an AP may affiliate with (such as by being controlled or managed by) one or more AP MLDs that operate on more than one communication link. As used herein, the term “STA” may refer to any type of wireless STA, such as a non-AP STA, a non-MLD STA, a non MLD non-AP STA, or the like. Similarly, the term “AP” may refer to any type of wireless AP, such as an AP MLD or a non-MLD AP, among other examples. In some examples, the sharing AP and one or more shared AP(s) may be affiliated with AP MLDs such that C-TDMA operations described herein are possible on each link of the MLD.

The format of the MU-RTS (TXS) frame may not be designed to carry information, such as an expected duration of the overall TXOP acquired by the sharing AP, when the TXOP will be shared with a certain AP, a duration of the TXOP that is being shared, traffic category or traffic flow or traffic characteristic for which the shared AP may use the TXOP, one or more STAs that may be served during the shared TXOP, or a combination thereof. An AP may extend existing frames for schedule announcement or TXOP allocation (such as extend the existing MU-RTS (TXS) framework, which may be associated with TXOP sharing or C-TDMA in some wireless communication systems).

However, signaling of the information associated with C-TDMA communication may add overhead by additional frame exchange overhead. Instead, the AP may determine ways to signal the above information within existing reserved fields, or other fields, of MU-RTS frames (such as MU-RTS TXS frame). Different fields within the MU-RTS (TXS) frame may be identified to signal various information to facilitate C-TDMA. Various ways to encode the information (such as encoding by a sharing AP) may be configured or determined so that the information may occupy less than a threshold capacity or size (e.g., of the field which contains the information).

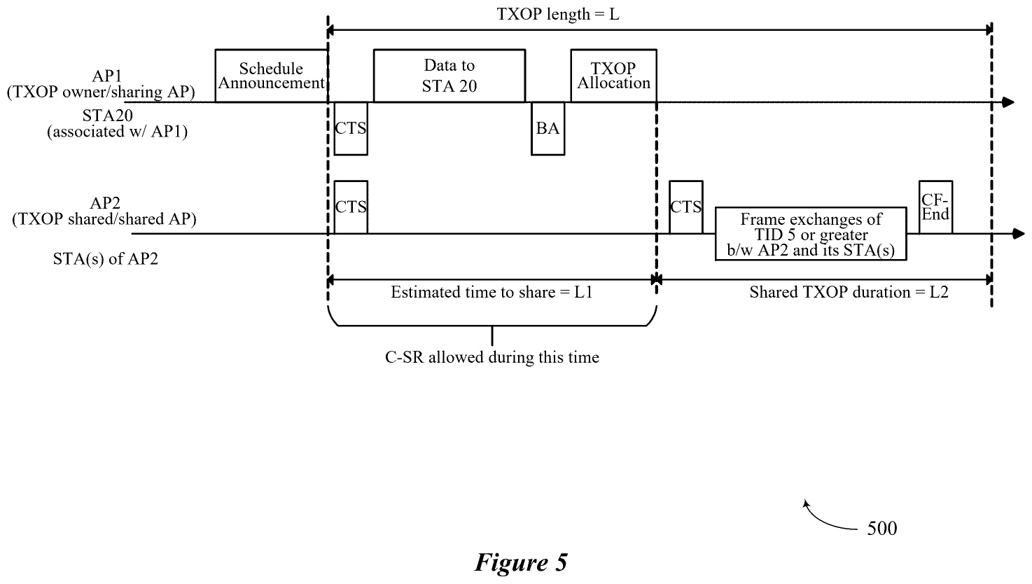

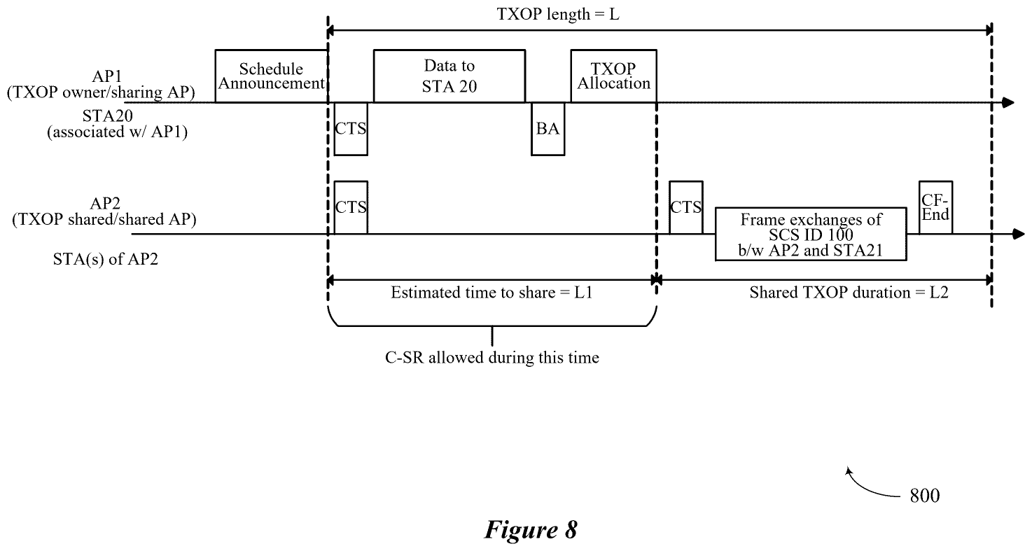

A signaling sequence (See, such as FIGS. 5 and 8) may illustrate signaling by an AP (such as to one or more other APs, to one or more STAs) associated with C-TDMA communication. The AP may transmit MU-RTS or MU-RTS TXS frames, which may be referred to herein as an MU-RTS (TXS) frame, for schedule announcement and may transmit a TXOP allocation frame (such as for indicating shared TXOP allocation). The schedule announcement frame may identify the AP(s) with whom the TXOP will be shared, provide the overall TXOP length, indicate when the TXOP will be shared with a certain AP, inform the shared AP(s) whom to serve during the shared TXOP, or any combination thereof. One or more of a regular MU-RTS frame or an MU-RTS TXS frame, a modified MU-RTS frame, a modified MU-RTS TXS frame, or a BSRP Trigger frame may be used as the schedule announcement frame. The schedule announcement frame may manage the medium access between shared AP(s) so that they do not interfere with each other and with the sharing AP, may enable a shared AP(s) to prepare for the shared TXOP (such as account for any processing delay), or may prepare an in-BSS STA(s) to be serviced by the AP.

The TXOP allocation frame may provide information about the shared TXOP. This frame may be an MU-RTS TXS frame, a same frame as the Schedule Allocation frame, or both. The TXOP allocation frame may be an extension of a baseline MU-RTS TXS frame to provide one or more of the following information: how long the TXOP is being shared with the AP identified in the frame, the traffic category or traffic flow or traffic characteristic for sharing, whom to serve during the shared TXOP, or a combination thereof.

In some examples, the AP may signal (such as via the MU-RTS frame or MU-RTS TXS frame, via a schedule announcement frame, via a TXOP allocation frame) the overall TXOP length (such as a duration of the TXOP). The overall TXOP length may inform the one or more shared APs how long to pause their contention. The following fields from the MU-RTS (TXS) frames may be used to signal the overall TXOP length: uplink (UL) Length subfield of Common Info field (12 bits) from MU-RTS (TXS) frames (such as with granularity of 2 microseconds (us) (may signal up to 8.192 milliseconds (ms))), UL Spatial Reuse subfield of Common Info field (16 bits) from MU-RTS (TXS) frames (such as with granularity of 1 us (may signal up to 65.536 ms)), Allocation Duration field of the User Info field (9 bits) from the MU-RTS TXS Frame (such as with granularity of 8 us or 16 us (may signal up to 4.096 or 8.192 ms)). Signaling by the AP of the overall TXOP length may not occupy or use all of the bits of a field (e.g., all 12, 16, or 9 bits). For example, the AP may signal via a subset of the bits of the field if the AP determines to encode the duration of the TXOP such that it uses a smaller number of bits (e.g., a threshold number of bits); the remaining bits may be used to signal some other information. The number of bits that the AP uses to signal the duration may depend on the encoding/granularity.

In some examples, the AP may use an encoding similar to a TXOP field in HE-SIG-A/U-SIG fields of PHY preambles. The AP may use 7 bits (e.g., B0-B6) to signal duration. In an example, if B0=0, TXOP (such as a duration of the TXOP) may be indicated in B1-B6 in units of 8 us. In another example, if B0=1, TXOP may be indicated in B1-B6 in units of 128 us, plus 512 us.

An encoding (such as using the aforementioned fields or other fields) may indicate the time allocated to the shared AP within the TXOP obtained by the sharing AP. For example, the AP may encode one or more of these fields to indicate the time allocated to the shared AP in units of 16 μs, or some other time unit. This may be applicable when the Schedule Announcement and/or the TXOP Allocation frame is an MU-RTS frame or MU-RTS TXS frame.

In some examples, the AP may signal (such as via the MU-RTS frame or MU-RTS TXS frame, via a schedule announcement frame, via a TXOP allocation frame) a length of the shared TXOP (such as a duration of the shared TXOP, a portion of the overall TXOP length). The following fields from MU-RTS TXS frame may be used: an Allocation Duration field of the User Info field (such as 9 bits), a Reserved field of the User Info field (such as 11 bits for HE variant and 10 bits for EHT variant), or a combination thereof. Signaling of the length of the shared TXOP may not occupy or use all of the bits of a field (e.g., all 9, 11, or 10 bits). For example, the AP may signal via a subset of the bits of the field if the AP determines to encode the duration of the shared portion of the TXOP such that it uses a smaller number of bits (e.g., a threshold number of bits); the remaining bits may be used to signal some other information. The number of bits that the AP uses to signal the duration may depend on the encoding/granularity.

An encoding (such as using the aforementioned fields or other fields) may indicate the time allocated to the shared AP within the TXOP obtained by the sharing AP. For example, the AP may indicate the time allocated to the shared AP in units of 16 μs, or some other time unit. This may be applicable when the Schedule Announcement frame and/or the TXOP Allocation frame is an MU-RTS frame or MU-RTS TXS frame.

In some examples, the AP may signal (such as via the MU-RTS frame or MU-RTS TXS frame, via a TXOP allocation frame, via a schedule announcement frame) traffic information (such as traffic identifier (TID), access category (AC), stream classification service (SCS)) associated with the shared TXOP, or any combination thereof. For example, the AP may signal a traffic priority, a traffic type, a traffic category, a traffic flow, or a combination thereof for communication in the shared TXOP or that the shared TXOP may or may not be used for peer-to-peer communication within the shared AP's BSS (such as may configure or instruct the sharing AP and/or the shared AP(s) to communicate in accordance with the signaled traffic information/parameters). The following fields from MU-RTS (TXS) frame may be used to signal the traffic information/parameters: two bits of a Reserved field in the User Info field to signal AC-level priority, three bits of the Reserved field in the User Info field to signal TID-level priority, eight bits of the Reserved field in the User Info field to signal which SCS flow ID to serve during the shared TXOP, reserved bits (such as two, three, or eight bits) of the Common Info field (such as any 2, 3, or 8 bits between B22-B63) to signal AC, TID, or SCS flow ID priority information, or a combination thereof.

In cases where traffic priority is signaled on an AC or TID level, encoding may be similar to the Preferred AC subfield of the Trigger dependent User Info field of the Basic Trigger frame. That is, if the sharing AP indicates the value corresponding to AC VI (or TID 5), the shared AP may be instructed (such as recommended, configured, indicated) to use AC_VI (or TID 5) or higher in the shared TXOP (such as for communication during the shared TXOP). The indication from the AP to use the indicated traffic priority/parameter may be a recommendation, or the indication may be a requirement.

In some examples, signaling of traffic priority is per-shared-AP. In other examples, in cases where the same signaling applies for all shared APs of the shared TXOP, the traffic priority information or traffic parameters may be included in a Common Info field or Special User Info field of the MU-RTS TXS frame. Any two or three of the reserved bits (such as of the Common Info field or the Special User Info field) may be used for signaling the traffic priority information or traffic parameters. Signaling of traffic parameters may be applicable when the Schedule Announcement and/or the TXOP Allocation frame is an MU-RTS (TXS) frame.

In some examples, the AP may signal (such as via the MU-RTS frame or MU-RTS TXS frame, via a schedule announcement frame, via a TXOP allocation frame) a time during which the shared AP may expect the shared TXOP to occur. For example, the AP may estimate a time period during which the shared TXOP occurs, and may provide an estimate to the shared AP so that the shared AP may prepare for the shared TXOP (such as construct PPDUs/A-MPDUs, make scheduling decisions, etc.). In some examples, the estimate may be an estimated time offset between transmission of the schedule announcement frame and a beginning of the shared TXOP. In some examples, the estimate may be an estimate (such as a subset of the bits) of the time synchronization function (TSF) at which the TXOP will be shared. The following fields from MU-RTS (TXS) frame may be used to signal the estimated time offset: between 3 to 6 bits of a Reserved field in the User Info field, between 3 to 6 Reserved bits of the Common Info field (such as any combination of 3 to 6 bits between B22-B63 of Common Info), or a combination thereof.

The timing information regarding the shared TXOP may indicate the delta time (such as a time offset) between a time at which the schedule announcement frame is transmitted and a time that the TXOP Allocation frame may be expected by the shared AP. The estimated time offset may be a coarse estimate, (such as in units of or with granularity of 256 μs, 512 μs, or 1 ms). Signaling of the expected timing of the shared TXOP may be applicable when the Schedule Announcement and/or the TXOP Allocation frame is an MU-RTS (TXS) frame.

In some examples, the sharing AP may share the TXOP with multiple shared APs. In an example, the AP may transmit a first TXOP allocation frame indicating a first time offset (e.g., a first duration of time that is pending) until sharing with a first shared AP, and may transmit a second TXOP allocation frame indicating a second time offset (e.g., a second duration of time that is pending) until sharing with a second shared AP occurs.

In some examples, the AP may signal (such as via the MU-RTS frame or MU-RTS TXS frame, via a TXOP allocation frame, via a schedule announcement frame) wireless communication devices (such as STAs, other APs) that the shared AP serves during the shared TXOP. For example, in relay architectures, such signaling may enable the sharing AP to arrange transfer of information from a root AP (such as which may be the shared AP) to a desired client (or client to root AP). The following fields from MU-RTS (TXS) frame may be used to signal the target wireless communication devices to be served during the TXOP: one or more bits in the Reserved field in the User Info field, one or more bits (such as 11 or 12 bits) of the Reserved bits of the Common Info field (such as any contiguous 12 bits between B22-B63 of Common Info), or a combination thereof. These bits may signal the 11/12 bits of the Association Identifier (AID) of the STA, which is to be served during the shared TXOP. If the STA to serve is an AP, the 11/12 bits may signal an identifier (such as a modified identifier) of the shared AP.

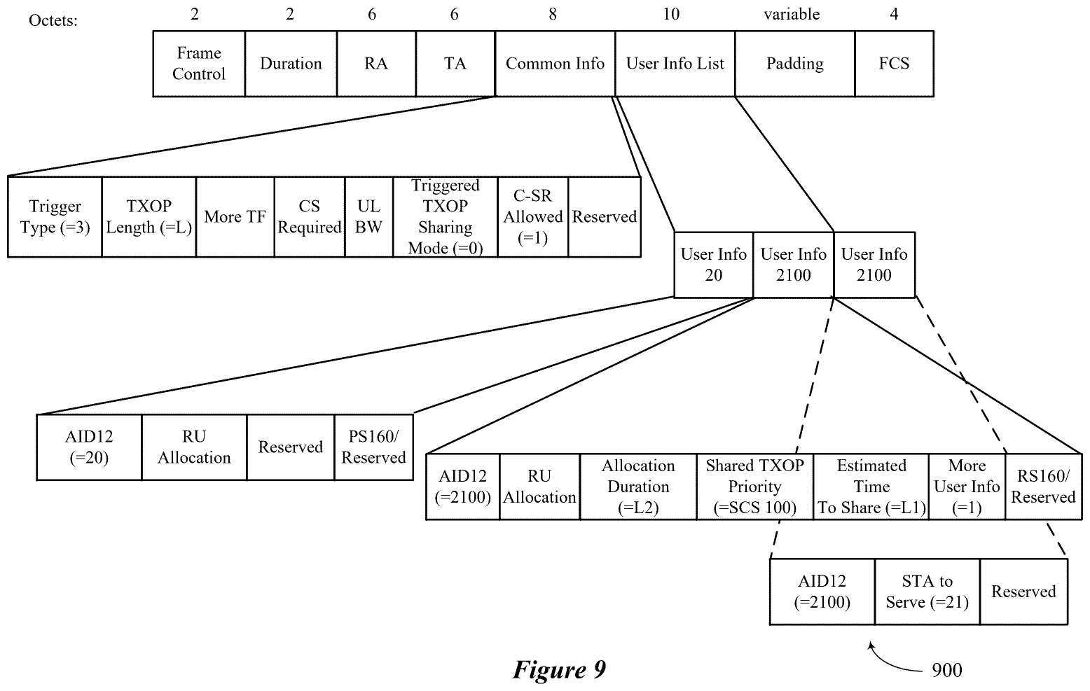

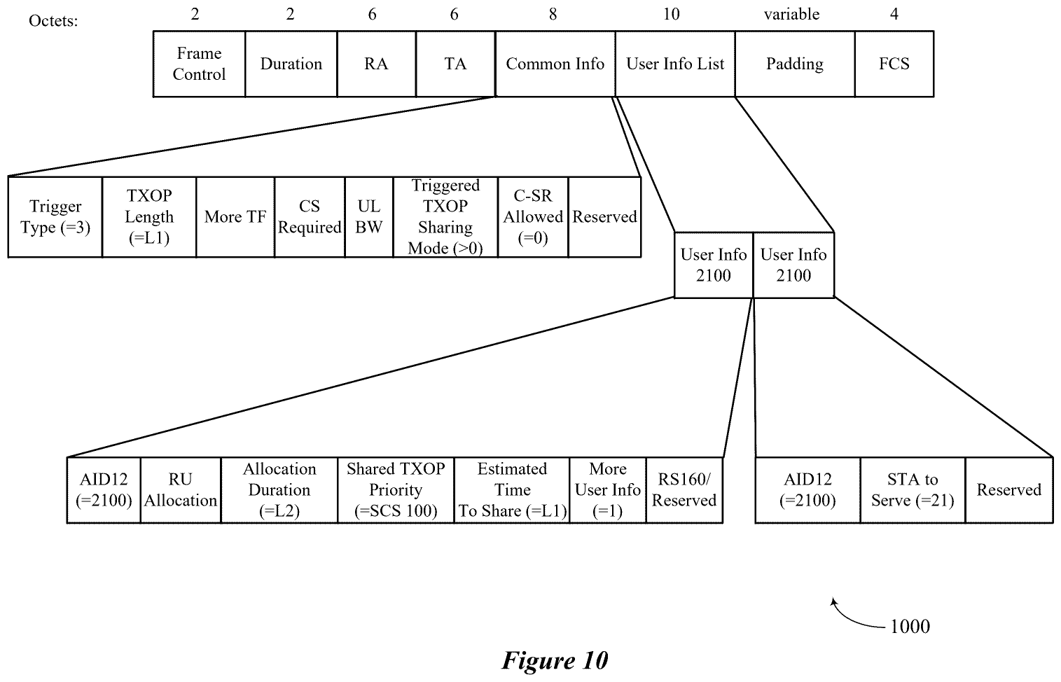

In some examples, when identifying a shared AP (See, e.g., “STA to serve” field or “AID12” field with reference to FIGS. 9 and 10, via which the sharing AP may signal an ID of the shared AP), the most significant bit of the identifier of the shared AP may be set to 1 so that the IDs assigned to the shared APs are greater than 2007, and hence, do not collide with the AID of associated STAs. Signaling of which wireless communication devices (such as STAs, APs) to serve during the TXOP may be applicable in cases where the Schedule Announcement and/or the TXOP allocation frame is an MU-RTS (TXS) frame.

In some examples, the AP may indicate information about one or more STAs to serve during the TXOP via a User Info field. The User Info field may include 10 or 11 reserved bits (depending on variant). The bits in the user info field may be insufficient to signal 11 or 12 bits of an AID associated with an STA to serve. In some examples, the AP may assign (such as either explicitly or implicitly through a rule) a short AID value (such as an AID value that is 5-7 bits) to associated STAs and neighboring APs. In such examples, instead of signaling 11/12 bits of AID, the User Info field may signal the short AID. Such implementation of a short AID may be applicable in cases where the Schedule Announcement frame is a MU-RTS (TXS) Trigger frame.

In some examples, the AP may signal more than one user info field per AID (such as an STA may receive a plurality of user info fields associated/addressed to the STA). A first User Info field for the AID and a second User Info field for the AID may have different formats. The first User Info field may include AID12, RU Allocation, Allocation Duration, PS160, and other fields related to the shared TXOP (such as Shared TXOP Priority, traffic parameters, Estimated Time to shared TXOP, etc.). The second User Info field may include AID12 and an AID of the STA that the shared AP serves during the shared TXOP. Additionally, or alternatively, the first User Info field may include an indication of whether the duplicate User Info field (such as the second user info field) is present. See, e.g., FIG. 9. The “More User Info” field may have a value of one, which may indicate the presence of the second user info field 2100. The signaling of more than one user info field per AID (such as a user info field and a duplicate user info filed) may be applicable for a MU-RTS (TXS) frame as well as a buffer status report poll (BSRP) Trigger frame. In addition to carrying information about the STA that may be served in the shared TXOP, the second User Info field may carry additional information to facilitate C-TDMA communications.

The schedule announcement frame may be an MU-RTS or MU-RTS TXS frame. By using the MU-RTS frame of the MU-RTS TXS frame, the sharing AP may not know an identity of the AP(s)/non-AP STA(s) that responded to the MU-RTS (TXS) frame (such as because the CTS response to MU-RTS (TXS) may be sent in a non-HT duplicate format). The CTS frames responding to the MU-RTS frame may be superimposed, and the sharing AP may not identify how many (such as a quantity of) wireless communication devices responded, or which wireless communication devices responded.

In some examples, the AP may use a modified MU-RTS (TXS) frame, which may be similar to a regular MU-RTS (TXS) frame, except that the response to the modified MU-RTS (TXS) frame may be sent in a TB PPDU. The sharing AP may assign different AP(s)/non-AP STA(s) to orthogonal frequency resources such as Resource Units (RUs). In this way, the sharing AP may know how many wireless communication devices responded or which wireless communication devices responded. Additionally, or alternatively, the AP may use a BSRP Trigger frame. Responses to the BSRP Trigger frame may be in a TB PPDU format. In this way, the sharing AP may know how many wireless communication devices responded or which wireless communication devices responded. In some examples, in response to the BSRP Trigger frame, the shared AP(s) may inform the sharing AP how many resources of the TXOP (such as which portion of the TXOP) the shared AP requests (such as uses or will use) in the shared TXOP. Thus, an advantage of using the BSRP Trigger frame is that the sharing AP may obtain or determine a good estimate of how much of the shared TXOP each of the shared APs may use or communicate over.

In some network topologies, it may be desirable to enable additional coordination by allowing friendly BSS's to perform coordinated spatial reuse (C-SR) within the C-TDMA TXOP (such as shared TXOP). In some examples, a sharing AP1 may share the TXOP via C-TDMA with an AP2, an AP3, and an AP4 and additionally may allow an AP5 to perform C-SR. The sharing AP may limit such C-SR opportunities to the in-BSS portion of the TXOP (e.g., the duration when the AP1 performs frame exchanges with its associated STAs). In such examples, the Schedule Announcement frame may indicate whether C-SR is allowed (such as enabled) in the current (such as indicated) TXOP.

In cases where the sharing AP indicates that C-SR is allowed in the current TXOP, the neighboring APs (such as AP 5) that receive the Schedule Announcement frame may elect or determine to not set their NAV so that the AP may serve STAs associated to it. Additionally, or alternatively, the sharing AP may serve its inner STAs (such as STAs that have high SINR, above a threshold) and not serve other STAs (such as STAs that have low SINR, below a threshold). An AP (such as AP5) that performs C-SR may limit frame exchanges with its inner STAs.

In some examples, the AP may use a same frame (such as a same frame type) for signaling both the schedule announcement frame and the TXOP allocation frame. For example, the Schedule Allocation frame and the TXOP Allocation frame may be of the same type and may have similar formats. In some examples, the AP may use a reserved bit (such as binary flag) from the User Info field to signal “TXOP shared”. The Schedule Announcement frame and the TXOP Allocation frame may both include multiple User Info fields (such as corresponding to a set or list of APs associated with the BSS or associated with the schedule announcement frame and the TXOP allocation frame). In some examples, the AP may set the bit for each AP to 0 to indicate that the frame is a schedule announcement frame. In some other examples, the “TXOP shared” bit may be set to 1 in a user info field corresponding to a single AP (such as or one or more APs) to indicate that the TXOP is being shared with the AP. The “TXOP shared” bit may be set to 0 in a user info field corresponding to one or more other APs to indicate that the TXOP will be shared sometime in the future with the one or more other APs. In other words, to indicate that the field is a TXOP allocation field (such as, contrary to a schedule announcement frame) the AP may set at least one of the “TXOP Shared” bits in the User Info fields to 1.

FIG. 5 shows an example of a timing diagram 500 that supports signaling details for C-TDMA. The timing diagram 500 may implement or be implemented by aspects of the wireless communication network 100. For example, the timing diagram 500 may illustrate signaling between an AP1, an AP2, an STA20, and other STAs, which may be examples of corresponding devices described herein.

L may be a duration of the overall TXOP. L1 may be a time offset between transmission of the schedule announcement frame and the shared TXOP. L2 may be a duration of a portion of the TXOP that is shared between a first AP (such as a sharing AP) and a second AP (such as a shared AP).

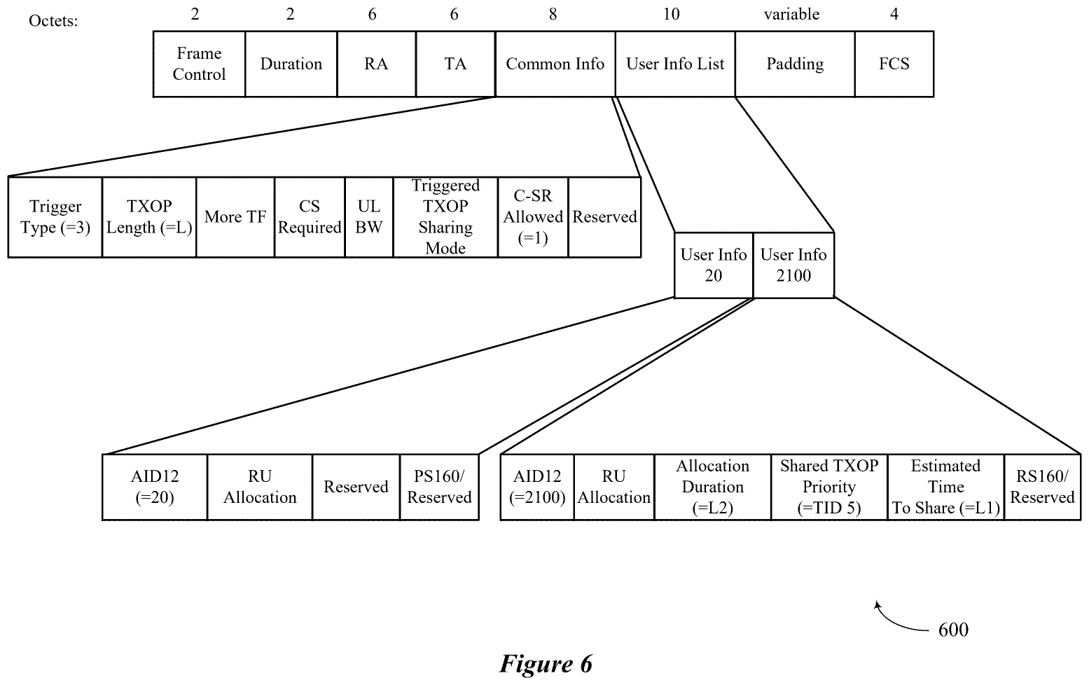

FIG. 6 shows an example of a frame 600 that supports signaling details for C-TDMA. The frame 600 may be an example of a schedule announcement frame in accordance with examples described herein.

A sharing AP may utilize one or more bits within the common info and the user info (such as one or more user info fields of a user info list such as user info 20 or user info field 2100), or any other bits (such as reserved bits) in the frame 600, to indicate one or more transmission parameters for communication during a portion of a TXOP that is shared between a sharing AP and a shared AP in accordance with examples described herein.

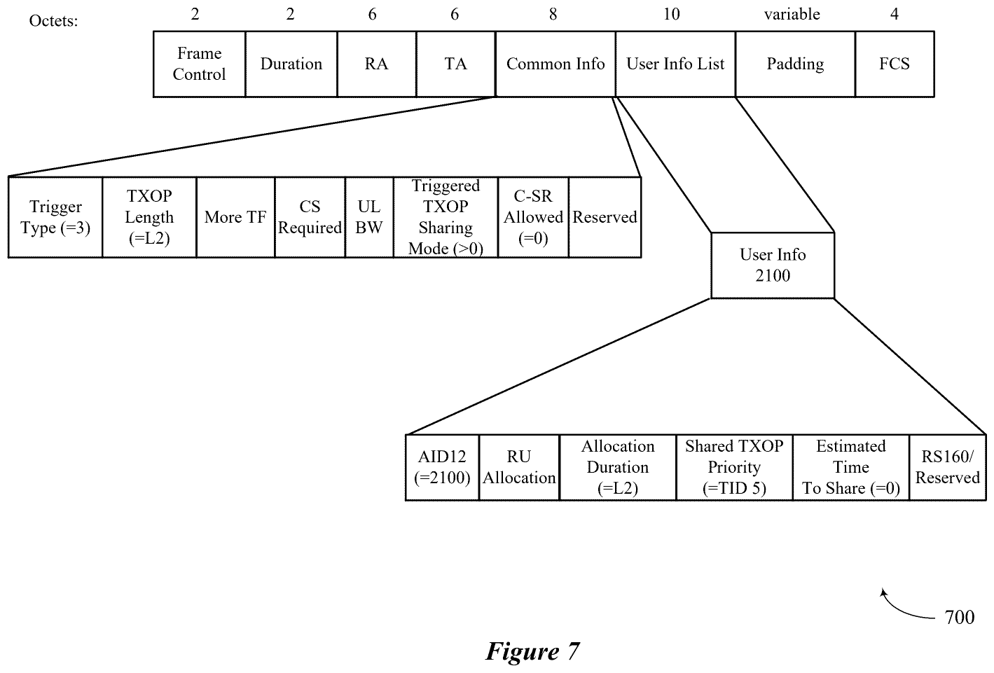

FIG. 7 shows an example of a frame 700 that supports signaling details for C-TDMA. The frame 700 may be an example of a TXOP allocation field in accordance with examples described herein.

A sharing AP may utilize one or more bits within the common info and the user info (such as one or more user info fields of a user info list such as user info field 2100), or any other bits (such as reserved bits) in the frame 700, to indicate one or more transmission parameters for communication during a portion of a TXOP that is shared between a sharing AP and a shared AP in accordance with examples described herein.

FIG. 8 shows an example of a timing diagram 800 that supports signaling details for C-TDMA. The timing diagram 800 may implement or be implemented by aspects of the wireless communication network 100. For example, the timing diagram 800 may illustrate signaling between an AP1, an AP2, an STA20, and an STA21, which may be examples of corresponding devices described herein.

L may be a duration of the TXOP. L1 may be a time offset between transmission of the schedule announcement frame and the shared TXOP. L2 may be a duration of a portion of the TXOP that is shared between a first AP (such as a sharing AP) and a second AP (such as a shared AP).

FIG. 9 shows an example of a frame 900 that supports signaling details for C-TDMA. The frame 900 may be an example of a schedule announcement frame in accordance with examples described herein.

A sharing AP may utilize one or more bits within the common info and the user info (such as one or more user info fields of a user info list such as user info 20, a first user info field 2100, a second user info field 2100), or any other bits (such as reserved bits) in the frame 900, to indicate one or more transmission parameters for communication during a portion of a TXOP that is shared between a sharing AP and a shared AP in accordance with examples described herein.

FIG. 10 shows an example of a frame 1000 that supports signaling details for C-TDMA. The frame 1000 may be an example of a TXOP allocation field in accordance with examples described herein.

A sharing AP may utilize one or more bits within the common info and the user info (such as one or more user info fields of a user info list such as a first user info field 2100, a second user info field 2100), or any other bits (such as reserved bits) in the frame 1000, to indicate one or more transmission parameters for communication during a portion of a TXOP that is shared between a sharing AP and a shared AP in accordance with examples described herein.

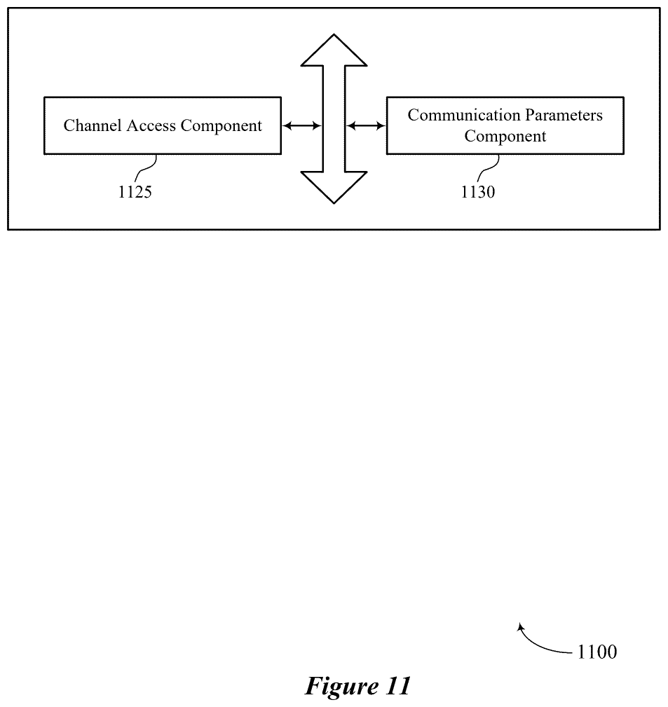

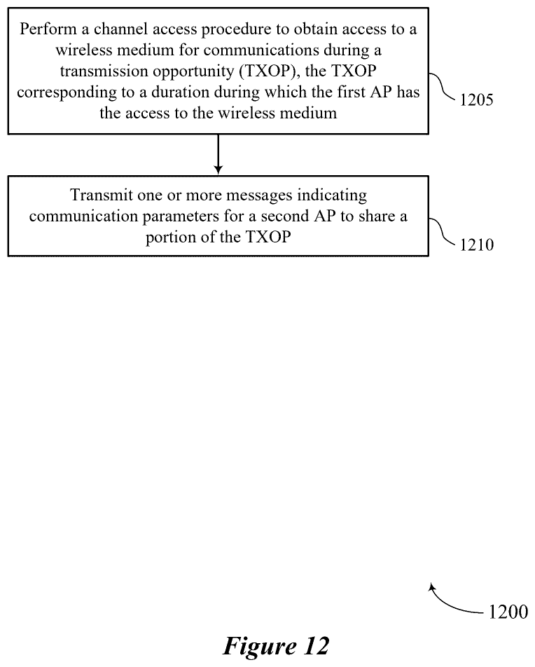

FIG. 11 shows a block diagram of an example wireless communication device 1100 that supports signaling details for C-TDMA. In some examples, the wireless communication device 1100 is configured to perform the process 1200 described with reference to FIG. 12. The wireless communication device 1100 may include one or more chips, SoCs, chipsets, packages, components or devices that individually or collectively constitute or include a processing system. The processing system may interface with other components of the wireless communication device 1100, and may generally process information (such as inputs or signals) received from such other components and output information (such as outputs or signals) to such other components. In some aspects, an example chip may include a processing system, a first interface to output or transmit information and a second interface to receive or obtain information. For example, the first interface may refer to an interface between the processing system of the chip and a transmission component, such that the wireless communication device 1100 may transmit the information output from the chip. In such an example, the second interface may refer to an interface between the processing system of the chip and a reception component, such that the wireless communication device 1100 may receive information that is then passed to the processing system. In some such examples, the first interface also may obtain information, such as from the transmission component, and the second interface also may output information, such as to the reception component.

The processing system of the wireless communication device 1100 includes processor (or “processing”) circuitry in the form of one or multiple processors, microprocessors, processing units (such as central processing units (CPUs), graphics processing units (GPUs), neural processing units (NPUs) (also referred to as neural network processors or deep learning processors (DLPs)), or digital signal processors (DSPs)), processing blocks, application-specific integrated circuits (ASIC), programmable logic devices (PLDs) (such as field programmable gate arrays (FPGAs)), or other discrete gate or transistor logic or circuitry (all of which may be generally referred to herein individually as “processors” or collectively as “the processor” or “the processor circuitry”). One or more of the processors may be individually or collectively configurable or configured to perform various functions or operations described herein. The processing system may further include memory circuitry in the form of one or more memory devices, memory blocks, memory elements or other discrete gate or transistor logic or circuitry, each of which may include tangible storage media such as random-access memory (RAM) or ROM, or combinations thereof (all of which may be generally referred to herein individually as “memories” or collectively as “the memory” or “the memory circuitry”). One or more of the memories may be coupled with one or more of the processors and may individually or collectively store processor-executable code that, when executed by one or more of the processors, may configure one or more of the processors to perform various functions or operations described herein. Additionally, or alternatively, in some examples, one or more of the processors may be preconfigured to perform various functions or operations described herein without requiring configuration by software. The processing system may further include or be coupled with one or more modems (such as a Wi-Fi (such as IEEE compliant) modem or a cellular (such as 3GPP 4G LTE, 5G or 6G compliant) modem). In some implementations, one or more processors of the processing system include or implement one or more of the modems. The processing system may further include or be coupled with multiple radios (collectively “the radio”), multiple RF chains or multiple transceivers, each of which may in turn be coupled with one or more of multiple antennas. In some implementations, one or more processors of the processing system include or implement one or more of the radios, RF chains or transceivers.

In some examples, the wireless communication device 1100 can be configurable or configured for use in an AP, such as the AP 102 described with reference to FIG. 1. In some other examples, the wireless communication device 1100 can be an AP that includes such a processing system and other components including multiple antennas. The wireless communication device 1100 is capable of transmitting and receiving wireless communications in the form of, for example, wireless packets. For example, the wireless communication device 1100 can be configurable or configured to transmit and receive packets in the form of physical layer PPDUs and MPDUs conforming to one or more of the IEEE 802.11 family of wireless communication protocol standards. In some other examples, the wireless communication device 1100 can be configurable or configured to transmit and receive signals and communications conforming to one or more 3GPP specifications including those for 5G NR or 6G. In some examples, the wireless communication device 1100 also includes or can be coupled with one or more application processors which may be further coupled with one or more other memories. In some examples, the wireless communication device 1100 further includes at least one external network interface coupled with the processing system that enables communication with a core network or backhaul network that enables the wireless communication device 1100 to gain access to external networks including the Internet.

The wireless communication device 1100 includes a channel access component 1125 and a communication parameters component 1130. Portions of one or more of the channel access component 1125 and the communication parameters component 1130 may be implemented at least in part in hardware or firmware. For example, one or more of the channel access component 1125 and the communication parameters component 1130 may be implemented at least in part by at least a processor or a modem. In some examples, portions of one or more of the channel access component 1125 and the communication parameters component 1130 may be implemented at least in part by a processor and software in the form of processor-executable code stored in memory.

The channel access component 1125 is configurable or configured to perform a channel access procedure to obtain access to a wireless medium for communications during a TXOP, the TXOP corresponding to a duration during which the first AP has the access to the wireless medium. The communication parameters component 1130 is configurable or configured to transmit one or more messages indicating communication parameters for a second AP to share a portion of the TXOP.

In some examples, the one or more messages include a first message that indicates a first set of communication parameters for the second AP to share the portion of the TXOP and a second message that indicates a second set of communication parameters for the second AP to share the portion of the TXOP.

In some examples, the first message is a schedule announcement frame.

In some examples, the second message is a TXOP allocation frame.

In some examples, the first message, second message, or both indicate the duration of the TXOP.

In some examples, the first message, second message, or both indicate a second duration of the portion of the TXOP that is shared with the second AP.

In some examples, the first message, second message, or both indicate a traffic type, a traffic category, a traffic flow, or a combination thereof associated with communication by the second AP during the portion of the TXOP that is shared with the second AP.

In some examples, the first message indicates an estimated time offset between transmission of the first message and a beginning of the portion of the TXOP that is shared with the second AP.

In some examples, the first message, second message, or both indicate an identifier of a wireless communication device served by the second AP during the portion of the TXOP that is shared with the second AP.

FIG. 12 shows a flowchart illustrating an example process 1200 performable by or at a first AP that supports signaling details for C-TDMA. The operations of the process 1200 may be implemented by a first AP or its components as described herein. For example, the process 1200 may be performed by a wireless communication device, such as the wireless communication device 1100 described with reference to FIG. 11, operating as or within a wireless AP. In some examples, the process 1200 may be performed by a wireless AP, such as one of the APs 102 described with reference to FIG. 1.

In some examples, in 1205, the first AP may perform a channel access procedure to obtain access to a wireless medium for communications during a TXOP, the TXOP corresponding to a duration during which the first AP has the access to the wireless medium. The operations of 1205 may be performed in accordance with examples as disclosed herein. In some implementations, aspects of the operations of 1205 may be performed by a channel access component 1125 as described with reference to FIG. 11.

In some examples, in 1210, the first AP may transmit one or more messages indicating communication parameters for a second AP to share a portion of the TXOP. The operations of 1210 may be performed in accordance with examples as disclosed herein. In some implementations, aspects of the operations of 1210 may be performed by a communication parameters component 1130 as described with reference to FIG. 11.

Implementation examples are described in the following numbered clauses:

Aspect 1: A method by a first AP, comprising: performing a channel access procedure to obtain access to a wireless medium for communications during a TXOP, the TXOP corresponding to a duration during which the first AP has the access to the wireless medium; and transmitting one or more messages indicating communication parameters for a second AP to share a portion of the TXOP.

Aspect 2: The method of aspect 1, wherein the one or more messages comprise a first message that indicates a first set of communication parameters for the second AP to share the portion of the TXOP and a second message that indicates a second set of communication parameters for the second AP to share the portion of the TXOP.

Aspect 3: The method of aspect 2, wherein the first message is a schedule announcement frame.

Aspect 4: The method of any of aspects 2 through 3, wherein the second message is a TXOP allocation frame.

Aspect 5: The method of any of aspects 2 through 4, wherein the first message, the second message, or both indicate the duration of the TXOP.

Aspect 6: The method of any of aspects 2 through 5, wherein the first message, the second message, or both, indicate a second duration of the portion of the TXOP that is shared with the second AP.

Aspect 7: The method of aspect 6, wherein the first message, the second message, or both comprise an allocation duration field, the allocation duration field comprises nine bits indicating the second duration.

Aspect 8: The method of any of aspects 6 through 7, wherein indication of the second duration is in accordance with a sixteen microsecond granularity.

Aspect 9: The method of any of aspects 2 through 8, wherein the first message, the second message, or both indicate a traffic type, a traffic category, a traffic flow, or a combination thereof associated with communication by the second AP during the portion of the TXOP that is shared with the second AP.

Aspect 10: The method of any of aspects 2 through 9, wherein the first message indicates an estimated time offset between transmission of the first message and a beginning of the portion of the TXOP that is shared with the second AP.

Aspect 11: The method of any of aspects 2 through 9, wherein the first message, the second message, or both indicate an identifier of a wireless communication device served by the second AP during the portion of the TXOP that is shared with the second AP.

Aspect 12: The method of any of aspects 2 through 11, wherein the first message, the second message, or both indicate one or more in-basic service set (BSS) stations (STAs) serviced by the first AP.

Aspect 13: The method of any of aspects 1 through 12, wherein the one or more messages indicate the communication parameters for a plurality of APs including the second AP to share the portion of the TXOP.

Aspect 14: A method by a second AP, comprising: receiving one or more first messages indicating communication parameters for the second AP to share a portion of a transmission opportunity (TXOP), the TXOP corresponding to a duration during which a first AP has access to a wireless medium; and communicating one or more second messages via the portion of the TXOP that is shared with the second AP in accordance with the communication parameters.

Aspect 15: The method of aspect 14, wherein the one or more messages comprise a first message that indicates a first set of communication parameters for the second AP to share the portion of the TXOP and a second message that indicates a second set of communication parameters for the second AP to share the portion of the TXOP.

Aspect 16: The method of aspect 15, wherein the first message is a schedule announcement frame.

Aspect 17: The method of any of aspects 15-16, wherein the second message is a TXOP allocation frame.

Aspect 18: The method of any of aspects 15-17, wherein the first message, the second message, or both indicates the duration of the TXOP.

Aspect 19: The method of any of aspects 15-18, wherein the first message, the second message, or both, indicates a second duration of the portion of the TXOP that is shared with the second AP.

Aspect 20: The method of aspect 19, wherein the first message, the second message, or both comprise an allocation duration field, the allocation duration field comprises nine bits indicating the second duration.

Aspect 21: The method of any of aspects 19-20, wherein indication of the second duration is in accordance with a sixteen microsecond granularity.

Aspect 22: The method of any of aspects 15-21, wherein the first message, the second message, or both indicate a traffic type, a traffic category, a traffic flow, or a combination thereof associated with communication by the second AP during the portion of the TXOP that is shared with the second AP.

Aspect 23: The method of any of aspects 15-22, wherein the first message indicates an estimated time offset between transmission of the first message and a beginning of the portion of the TXOP that is shared with the second AP.

Aspect 24: The method of any of aspects 15-23, wherein the first message, the second message, or both indicate an identifier of a wireless communication device served by the second AP during the portion of the TXOP that is shared with the second AP.

Aspect 25: The method of any of aspects 15-24, wherein the first message, the second message, or both indicate one or more in-basic service set (BSS) stations (STAs) serviced by the first AP.

Aspect 26: The method of any of aspects 14-25, wherein the one or more messages indicate the communication parameters for a plurality of APs including the second AP to share the portion of the TXOP.

Aspect 27: A first AP comprising one or more memories storing processor-executable code, and one or more processors coupled with the one or more memories and individually or collectively operable to execute the code to cause the first AP to perform a method of any of aspects 1 through 13.

Aspect 28: A first AP comprising at least one means for performing a method of any of aspects 1 through 13.

Aspect 29: A non-transitory computer-readable medium storing code the code comprising instructions executable by one or more processors to perform a method of any of aspects 1 through 13.

Aspect 30: A second AP comprising one or more memories storing processor-executable code, and one or more processors coupled with the one or more memories and individually or collectively operable to execute the code to cause the second AP to perform a method of any of aspects 14 through 26.

Aspect 31: A second AP comprising at least one means for performing a method of any of aspects 14 through 26.

Aspect 32: A non-transitory computer-readable medium storing code the code comprising instructions executable by one or more processors to perform a method of any of aspects 14-through 26.

As used herein, the term “determine” or “determining” encompasses a wide variety of actions and, therefore, “determining” can include calculating, computing, processing, deriving, estimating, investigating, looking up (such as via looking up in a table, a database, or another data structure), inferring, ascertaining, or measuring, among other possibilities. Also, “determining” can include receiving (such as receiving information), accessing (such as accessing data stored in memory) or transmitting (such as transmitting information), among other possibilities. Additionally, “determining” can include resolving, selecting, obtaining, choosing, establishing and other such similar actions.

As used herein, a phrase referring to “at least one of” or “one or more of” a list of items refers to any combination of those items, including single members. As an example, “at least one of: a, b, or c” is intended to cover: a, b, c, a-b, a-c, b-c, and a-b-c. As used herein, “or” is intended to be interpreted in the inclusive sense, unless otherwise explicitly indicated. For example, “a or b” may include a only, b only, or a combination of a and b. Furthermore, as used herein, a phrase referring to “a” or “an” element refers to one or more of such elements acting individually or collectively to perform the recited function(s). Additionally, a “set” refers to one or more items, and a “subset” refers to less than a whole set, but non-empty.

As used herein, “based on” is intended to be interpreted in the inclusive sense, unless otherwise explicitly indicated. For example, “based on” may be used interchangeably with “based at least in part on,” “associated with,” “in association with,” or “in accordance with” unless otherwise explicitly indicated. Specifically, unless a phrase refers to “based on only ‘a,” or the equivalent in context, whatever it is that is “based on ‘a,’” or “based at least in part on ‘a,’” may be based on “a” alone or based on a combination of “a” and one or more other factors, conditions, or information.

As used herein, “satisfying a threshold” may, depending on the context, refer to a value being greater than the threshold, greater than or equal to the threshold, less than the threshold, less than or equal to the threshold, equal to the threshold, not equal to the threshold, or the like.

The various illustrative components, logic, logical blocks, modules, circuits, operations, and algorithm processes described in connection with the examples disclosed herein may be implemented as electronic hardware, firmware, software, or combinations of hardware, firmware, or software, including the structures disclosed in this specification and the structural equivalents thereof. The interchangeability of hardware, firmware and software has been described generally, in terms of functionality, and illustrated in the various illustrative components, blocks, modules, circuits and processes described above. Whether such functionality is implemented in hardware, firmware or software depends upon the particular application and design constraints imposed on the overall system.

Various modifications to the examples described in this disclosure may be readily apparent to persons having ordinary skill in the art, and the generic principles defined herein may be applied to other examples without departing from the spirit or scope of this disclosure. Thus, the claims are not intended to be limited to the examples shown herein, but are to be accorded the widest scope consistent with this disclosure, the principles and the novel features disclosed herein.

Additionally, various features that are described in this specification in the context of separate examples also can be implemented in combination in a single implementation. Conversely, various features that are described in the context of a single implementation also can be implemented in multiple examples separately or in any suitable subcombination. As such, although features may be described above as acting in particular combinations, and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. Further, the drawings may schematically depict one or more example processes in the form of a flowchart or flow diagram. However, other operations that are not depicted can be incorporated in the example processes that are schematically illustrated. For example, one or more additional operations can be performed before, after, simultaneously, or between any of the illustrated operations. In some circumstances, multitasking and parallel processing may be advantageous. Moreover, the separation of various system components in the examples described above should not be understood as requiring such separation in all examples, and it should be understood that the described program components and systems can generally be integrated together in a single software product or packaged into multiple software products.

What is claimed is:

1. A first access point (AP), comprising:
a processing system that includes processor circuitry and memory circuitry that stores code, the processing system configured to cause the first AP to:
perform a channel access procedure to obtain access to a wireless medium for communications during a transmission opportunity (TXOP), the TXOP corresponding to a duration during which the first AP has the access to the wireless medium; and
transmit one or more messages indicating communication parameters for a second AP to share a portion of the TXOP.

2. The first AP of claim 1, wherein the one or more messages comprise a first message that indicates a first set of communication parameters for the second AP to share the portion of the TXOP and a second message that indicates a second set of communication parameters for the second AP to share the portion of the TXOP.

3. The first AP of claim 2, wherein the first message is a schedule announcement frame.

4. The first AP of claim 2, wherein the second message is a TXOP allocation frame.

5. The first AP of claim 2, wherein the first message, the second message, or both, indicate a second duration of the portion of the TXOP that is shared with the second AP.

6. The first AP of claim 5, wherein the first message, the second message, or both comprise an allocation duration field, and wherein the allocation duration field comprises nine bits indicating the second duration.

7. The first AP of claim 5, wherein indication of the second duration is in accordance with a sixteen microsecond granularity.

8. The first AP of claim 2, wherein the first message, the second message, or both indicate a traffic type, a traffic category, a traffic flow, or a combination thereof associated with communication by the second AP during the portion of the TXOP that is shared with the second AP.

9. The first AP of claim 2, wherein the first message indicates an estimated time offset between transmission of the first message and a beginning of the portion of the TXOP that is shared with the second AP.

10. The first AP of claim 2, wherein the first message, the second message, or both indicate an identifier of a wireless communication device served by the second AP during the portion of the TXOP that is shared with the second AP.

11. The first AP of claim 2, wherein the first message, the second message, or both indicate one or more in-basic service set (BSS) stations (STAs) serviced by the first AP.

12. The first AP of claim 1, wherein the one or more messages indicate the communication parameters for a plurality of APs including the second AP to share the portion of the TXOP.

13. A method by a first access point (AP), comprising:
performing a channel access procedure to obtain access to a wireless medium for communications during a transmission opportunity (TXOP), the TXOP corresponding to a duration during which the first AP has the access to the wireless medium; and
transmitting one or more messages indicating communication parameters for a second AP to share a portion of the TXOP.

14. The method of claim 13, wherein the one or more messages comprise a first message that indicates a first set of communication parameters for the second AP to share the portion of the TXOP and a second message that indicates a second set of communication parameters for the second AP to share the portion of the TXOP.

15. The method of claim 14, wherein the first message is a schedule announcement frame.

16. The method of claim 14, wherein the second message is a TXOP allocation frame.

17. The method of claim 14, wherein the first message, the second message, or both, indicate a second duration of the portion of the TXOP that is shared with the second AP.

18. The method of claim 17, wherein the first message, the second message, or both comprise an allocation duration field, and wherein the allocation duration field comprises nine bits indicating the second duration.

19. The method of claim 17, wherein indication of the second duration is in accordance with a sixteen microsecond granularity.

20. The method of claim 14, wherein the first message, the second message, or both indicate a traffic type, a traffic category, a traffic flow, or a combination thereof associated with communication by the second AP during the portion of the TXOP that is shared with the second AP.

21. The method of claim 14, wherein the first message indicates an estimated time offset between transmission of the first message and a beginning of the portion of the TXOP that is shared with the second AP.

22. The method of claim 14, wherein the first message, the second message, or both indicate an identifier of a wireless communication device served by the second AP during the portion of the TXOP that is shared with the second AP.

23. The method of claim 14, wherein the first message, the second message, or both indicate one or more in-basic service set (BSS) stations (STAs) serviced by the first AP.

24. The method of claim 13, wherein the one or more messages indicate the communication parameters for a plurality of APs including the second AP to share the portion of the TXOP.

25. A second access point (AP), comprising:
a processing system that includes processor circuitry and memory circuitry that stores code, the processing system configured to cause the second AP to:
receive one or more first messages indicating communication parameters for the second AP to share a portion of a transmission opportunity (TXOP), the TXOP corresponding to a duration during which a first AP has access to a wireless medium; and
communicate one or more second messages via the portion of the TXOP that is shared with the second AP in accordance with the communication parameters.

26. The second AP of claim 25, wherein the one or more first messages comprise a first message that indicates a first set of communication parameters for the second AP to share the portion of the TXOP and a second message that indicates a second set of communication parameters for the second AP to share the portion of the TXOP.

27. The second AP of claim 26, wherein the first message, the second message, or both, indicate a second duration of the portion of the TXOP that is shared with the second AP.

28. The second AP of claim 27, wherein the first message, the second message, or both comprise an allocation duration field, and wherein the allocation duration field comprises nine bits indicating the second duration.

29. The second AP of claim 27, wherein indication of the second duration is in accordance with a sixteen microsecond granularity.

30. A method by a second access point (AP), comprising:
receiving one or more first messages indicating communication parameters for the second AP to share a portion of a transmission opportunity (TXOP), the TXOP corresponding to a duration during which a first AP has access to a wireless medium; and
communicating one or more second messages via the portion of the TXOP that is shared with the second AP in accordance with the communication parameters.
